(19) United States
(12) Patent Application Publication
(10) Pub. No.: US 2005/0240701 A1
(43) Pub. Date: Oct. 27, 2005

(54) Interrupt control apparatus

(75) Inventors: Masanobu Kuboshima, Osaka (JP); Toshiya Kai, Osaka (JP)

Correspondence Address: MCDERMOTT, WILL & EMERY, 600 13th Street, N.W., WASHINGTON, DC, 20005-3096, US

(73) Assignee: Matsushita Electric Industrial Co., Ltd.

(21) Appl. No.: 11/115,270

(22) Filed: Apr. 27, 2005

(30) Foreign Application Priority Data
Apr. 27, 2004 (JP) 2004-131692

(51) Int. Cl. G06F 13/26

(52) U.S. Cl. 710/260

(57) ABSTRACT

Apparatus for controlling multiple interrupts comprises units for: pre-storing, for each interrupt cause, information identifying an interrupt processing program executed in response to occurrence of the interrupt cause and level information indicating the interrupt processing program level; comparing, upon occurrence of an interrupt cause, execution levels indicated by the level information and by an intra-CPU processor status word; saving, into an inside-memory stack area, CPU information including the processor status word and the program counter content in CPU; reading the CPU information from the stack area and restoring it into the CPU; performing control for, if the comparison result shows the level-information execution level is no lower than the processor-status-word level, having the saving unit save the CPU information before executing the corresponding interrupt processing program at a corresponding level, and having the restoration unit restore the CPU information after the interrupt processing program finishes being executed.

### BACKGROUND OF THE INVENTION

1. Field of the Invention

The present invention relates to interrupt control in computers, particularly to a technique for saving and restoring data that indicates the CPU status before and after execution of an interrupt processing program.

2. Description of the Related Art

Conventionally, computer systems have widely been used in which operation modes are controlled utilizing a central processing unit (CPU) that operates in at least two types of operation modes in order to, for example, protect the operating system (OS) that manages the computer resources and the like from being corrupted by an application program (AP).

Operation modes can be generally classified into (i) a type of mode in which utilization of computer resources is not restricted, and which are called, for example, a privileged mode, a kernel mode, or a supervisor call (SVC) mode, and (ii) another type of mode in which utilization of computer resources is restricted, and which are called, for example, a user mode, a non-privileged mode, and a problem mode. To each OS program and AP program, an execution level indicating in what operation mode the program should be executed is assigned using some method. In the following description, the execution level of a program to be executed in a mode in which utilization of computer resources such as input and output devices is not restricted will be referred to as a privileged level, and the execution level of a program to be executed in a mode in which utilization of computer resources is restricted will be referred to as a user level.

Normally, a privileged level is assigned in advance to each of the programs that constitute the core of an OS. Other programs such as ones constituting APs and non-core parts of the OS are treated as being at a user level.

In a conventional computer system, a specific bit in a processor status word (PSW) of a CPU expresses a current operation mode, that is, the execution level of a program currently being executed. Only programs at a privileged level are allowed to re-write the part of the PSW that shows the execution level and to access memory areas protected with what is called ring protection or the like. Programs at a user level are prohibited from accessing the part of the PSW that shows the execution level and the protected memory areas. When such prohibited access is attempted, it will be dealt as a system error.

Conventionally, computer systems perform what is called interrupt control. The following briefly explains interrupt control.

In a computer system, an interrupt level and an interrupt processing program are predetermined for each interrupt cause. When an interrupt cause has occurred during execution of a program, in the case where the interrupt level corresponding to the occurring interrupt cause shows a level higher than the interrupt mask level flag, which is a flag in the current PSW, execution of the program is suspended and after the interrupt mask level flag is updated so as to become equal to the interrupt level corresponding to the occurring interrupt cause, an operation in response to the interrupt cause is realized by temporarily executing the interrupt processing program, and subsequently execution of the original program being suspended is resumed.

In order to enable such suspension and resume of the program, the computer system saves, immediately before the start of the execution of the interrupt processing program, the content of the PSW of the CPU and the content of the program counter (PC) (hereafter, the content of the PSW and the content of the program counter together will be referred to as CPU information) into a specific memory area. When the execution of the interrupt processing program is finished, the saved CPU information is restored, in other words, the saved CPU information is re-set as the PSW and the PC of the CPU.

It should be noted that even while the interrupt processing program is being executed, the computer system suspends the interrupt processing program being executed if an interrupt cause has occurred that has a higher interrupt level than the interrupt processing program being executed, and copes with multiple interrupts by executing an interrupt processing program that corresponds to the occurring interrupt cause. Further, when multiple interrupts have occurred, the computer system saves and restores CPU information into and from a specific memory area, i.e. stack area, in a last-in-first-out (LIFO) manner.

It should be noted that, as a conventional technique for interrupt control to execute an interrupt processing program in response to occurrence of an interrupt cause, a method of interrupt response processing is disclosed in, for example, a publication of a Japanese patent application (the Japanese Unexamined Patent Application Publication H06-83640, pp. 2-4, FIGS. 1 to 3).

On an assumption that an interrupt control method is used that allows an interrupt processing program at a user level to be executed, it would be convenient to have an arrangement wherein the interrupt processing program at a user level is allowed to rewrite part of the CPU information that has been saved in a stack area due to occurrence of an interrupt. For example, in the case where it is possible to alter the value of a PC in the CPU information that has been saved in the stack area, since it is possible to arbitrarily change the position to come back to in the program at a user level at the time of restoration from the interrupt processing program at a user level, it becomes possible to realize a flexible interrupt control algorithm with the interrupt control program at a user level.

However, a program at a user level has low reliability and has a possibility of containing an improper program such as so-called viruses, unlike an interrupt processing program at a privileged level that is, for example, in the core of an OS and has high reliability.

Accordingly, in the case where an interrupt processing program at a user level is allowed to rewrite CPU information within a stack area, some problems as below will arise.

One of the problems is that there is a risk that an improper interrupt processing program at a user level may freely alter some part of the CPU information saved in the stack area that is related to the execution status of a program at a privileged level. Another problem is that an improper interrupt processing program at a user level may rewrite the PSW in the CPU information that shows the execution level so that it shows a privileged level and may take over the privileged level by taking advantage of the feature that when execution of the interrupt processing program is finished the rewritten CPU information is restored into the CPU.

### SUMMARY OF THE INVENTION

An object of the present invention is to solve any of these problems above and to provide an interrupt control apparatus that performs interrupt control so as to prevent an interrupt processing program at a user level from improperly manipulating CPU information while allowing the interrupt processing program at a user level to be executed.

In order to achieve the objects, the present invention provides an interrupt control apparatus for controlling multiple interrupts, comprising: an interrupt information storing unit pre-storing therein, for each of a plurality of interrupt causes, (i) a piece of interrupt processing information for identifying a corresponding interrupt processing program to be executed in response to occurrence of the interrupt cause and (ii) a piece of level information indicating whether an execution level of the corresponding interrupt processing program is a high level or a low level; a comparison unit operable to compare, when an interrupt cause has occurred, the execution level indicated by the piece of level information corresponding to the interrupt cause with an execution level indicated by a processor status word within a CPU; a saving unit operable to save CPU information into a stack area within a memory, the CPU information including a content of the processor status word and a content of a program counter within the CPU; a restoration unit operable to read the saved CPU information from the stack area and restores the read CPU information into the CPU; and an interrupt control unit operable to, in a case where a result of the comparison shows that the execution level indicated by the piece of level information corresponding to the interrupt cause is no lower than the execution level indicated by the processor status word, cause the saving unit to save the CPU information before the interrupt control unit executes the corresponding interrupt processing program at the corresponding execution level, and to cause the restoration unit to restore the CPU information after the execution of the corresponding interrupt processing program is finished.

According to the present invention, with the interrupt control apparatus having this arrangement, the CPU information saved in the stack area is alterable during execution of an interrupt processing program at a low level, i.e. at a user level; however, since while the interrupt processing program at a user level is being executed, the stack area stores therein no CPU information that is related to execution status of programs at privileged levels, it is not possible for the interrupt processing program at a user level to improperly rewrite the saved data related to execution status of interrupt processing programs at privileged levels.

It should be noted that, while being executed, the interrupt processing program at a user level is able to access a PC in the CPU information saved in the stack area that is related to execution status of a program at a user level and is able to alter the return address to an arbitrary address. Thus, it is possible to realize flexible interrupt response processing that is not confined to only interrupt processing programs. Further, it is possible to execute an interrupt processing program at a privileged level in a swift manner without suspension caused by occurrence of an interrupt cause corresponding to an interrupt processing program at a user level.

It is further acceptable to have an arrangement wherein in a case where the execution level indicated by the processor status word within the CPU indicates a low level after the saved CPU information is read from the stack area, the restoration unit forces the read CPU information to indicate a low level and restores the CPU information forced to indicate the low level into the CPU.

With this arrangement, the interrupt processing program at a user level is able to alter some part of the CPU information saved in the stack area, for example, the part that is to be re-set into the PC as the CPU information is restored when the execution of the interrupt processing program is finished; however, even if some other part of the CPU information that shows an execution level is rewritten so as to show a privileged level, such a part will be forcibly rewritten so as to show a user level when the CPU information is restored after the execution of the interrupt processing program is finished. Thus, it is possible to prevent a program at a user level from taking over a privileged level.

It is further acceptable that the interrupt control apparatus further comprises an abnormality detection unit operable to, in a case where the execution level indicated by the processor status word within the CPU indicates a low level and also the CPU information read from the stack area by the restoration unit indicates a high level, output information indicating that abnormality has occurred to outside of the interrupt control apparatus.

With this arrangement, in the case where an interrupt processing program at a user level rewrites part of the CPU information saved in a stack area that shows an execution level and attempts to have a program primarily at a user level operated at a privileged level, the computer system comprising this interrupt control apparatus is able to detect such an attempt as occurrence of abnormality.

The present invention also provides an interrupt control apparatus for controlling multiple interrupts, comprising: an interrupt information storing unit pre-storing therein, for each of a plurality of interrupt causes, (i) a piece of interrupt processing information for identifying a corresponding interrupt processing program to be executed in response to occurrence of the interrupt cause and (ii) a piece of level information indicating whether an execution level of the corresponding interrupt processing program is a high level or a low level; a saving unit operable to save CPU information into both a stack area within a memory indicated by a predetermined register and a protected area that is predetermined within a memory, the CPU information including a content of a processor status word and a content of a program counter within a CPU, and to save a stack pointer which is a content of the predetermined register into the protected area; a restoration unit operable to read the saved stack pointer from the protected area, to set the read stack pointer into the predetermined register, and to read the saved CPU information from the protected area and (i) in a case where such part of the CPU information read from the protected area that represents an execution level indicates a low level, to restore, into the CPU, the execution level part and such part of the CPU information saved in the stack area indicated by the predetermined register that represents other than an execution level and (ii) in a case where the execution level part of the CPU information read from the protected area indicates a high level, to restore, into the CPU, the CPU information read from the protected area; a protection unit operable to, in a case where an execution level present in the CPU indicates a low level, prevent an instruction for having data written into the protected area from being executed; and an interrupt control unit operable to, when an interrupt cause has occurred, cause the saving unit to save the CPU information before the interrupt control unit executes the corresponding interrupt processing program, and to cause the restoration unit to restore the CPU information after the execution of the corresponding interrupt processing program is finished.

With this arrangement, even while a program at a privilege level is being executed, it is possible to execute the interrupt processing program at a user level, and also although it is possible to rewrite the shift destination address used when the control shifts from an interrupt processing program at a user level to a program at a user level, it is not possible to rewrite the execution level. Thus, it is possible to prevent programs at user levels from taking over the privileged level.

The present invention further provides an interrupt control apparatus for controlling multiple interrupts, comprising: an interrupt information storing unit pre-storing therein, for each of a plurality of interrupt causes, (i) a piece of interrupt processing information for identifying a corresponding interrupt processing program to be executed in response to occurrence of the interrupt cause and (ii) a piece of level information indicating whether an execution level of the corresponding interrupt processing program is a high level or a low level; a saving unit operable to save CPU information into a stack area within a memory indicated by a predetermined register, the CPU information including a content of a processor status word and a content of a program counter within a CPU, and to save a stack pointer which is a content of the predetermined register into a protected area within a memory; a restoration unit operable to read the saved stack pointer from the protected area, to set the read stack pointer into the predetermined register, and to read the CPU information from the stack area indicated by the predetermined register, and to restore the read CPU information into the CPU; a first protection unit operable to, in a case where an execution level present in the CPU indicates a low level, prevent an instruction for having data written into the protected area from being executed; a second protection unit operable to, in the case where the execution level present in the CPU indicates a low level, prevent an instruction from being executed, the instruction being for having data written into one of stack areas indicated by stack pointers that are saved in the protected area and not yet read out; and an interrupt control unit operable to, when an interrupt cause has occurred, cause the saving unit to save the CPU information before the interrupt control unit executes the corresponding interrupt processing program, and to cause the restoration unit to restore the CPU information after the execution of the corresponding interrupt processing program is finished.

With this arrangement, it is possible to dynamically protect with a privilege the memory area in which the CPU information is saved and to prevent an interrupt processing program at a user level from rewriting the CPU information saved in the memory area.

It is further acceptable to have an arrangement wherein the saving unit further saves, into the protected area, a pair made up of the stack pointer and an execution level indicated by the process status word within the CPU, the instruction prevented from being executed by the second protection unit is only an instruction for having data written into such a stack area indicated by a stack pointer that is, out of the stack pointers saved in the protected area and not yet read out, paired up with an execution level indicating a high level, and the restoration unit reads the pair made up of the stack pointer and the execution level from the protected area, sets the read stack pointer into the predetermined register, reads such part of the CPU information that represents other than an execution level from the stack area indicated by the predetermined register, and restores the read part of the CPU information and the read execution level into the CPU.

With this arrangement, the interrupt processing program at a user level is allowed to rewrite only such part of the saved CPU information related to the execution status of the program at a user level that shows other than the execution levels.

It is further acceptable to have an arrangement wherein the saving unit further saves, into the protected area, a pair made up of the stack pointer and an execution level indicated by the process status word within the CPU, (i) in a case where a stack pointer immediately previously saved in the protected area and not yet read out is paired up with an execution level indicating a high level, the second protection unit prevents an instruction from being executed, the instruction being for having data written into a range starting from an address shown by the stack pointer and ending with a predetermined address, and (ii) in a case where the stack pointer immediately previously saved in the protected area and not yet read out is paired up with an execution level indicating a low level, the second protection unit prevents an instruction from being executed, the instruction being for having data written into a range starting from an address obtained by incrementing or decrementing, by a predetermined amount, the address shown by the stack pointer toward the predetermined address and ending with the predetermined address, and the restoration unit reads the pair made up of the stack pointer and the execution level from the protected area, sets the read stack pointer into the predetermined register, reads such part of the CPU information that represents other than an execution level from the stack area indicated by the predetermined register, and restores the read part of the CPU information and the read execution level into the CPU.

With this arrangement, by arranging in advance the data structure of the saved CPU information and the predetermined amount for the second protection unit so that the interrupt processing program at a user level is able to rewrite such part of the CPU information saved in the stack area that corresponds to the position of a PC portion for the program at a user level of which the execution has been suspended due to an interrupt, it is possible to allow the interrupt processing program at a user level to rewrite only such part and prohibit the interrupt processing program at a user level to rewrite other parts.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a functional block diagram of the interrupt control apparatus 100 according to the first embodiment of the present invention;

FIG. 2 is a flow chart that shows the interrupt control processing performed by the interrupt control apparatus 100;

FIG. 3 is a timing chart that shows the relationship between occurrence of interrupt causes and execution of interrupt processing programs;

FIG. 4 is a functional block diagram of the interrupt control apparatus 200 according to a modification example of the first embodiment;

FIG. 5 is a functional block diagram of the interrupt control apparatus 300 according to the second embodiment;

FIG. 6 is a flow chart that shows the interrupt control processing performed by the interrupt control apparatus 300;

FIG. 7 is a timing chart that shows the relationship between occurrence of interrupt causes and execution of interrupt processing programs;

FIG. 8 is a functional block diagram of the interrupt control apparatus 500 according to the third embodiment;

FIG. 9 is a flow chart that shows the interrupt control processing performed by the interrupt control apparatus 500;

FIG. 10 is a flow chart that shows the instruction execution processing performed by the interrupt control apparatus 500;

FIG. 11 is a functional block diagram of the interrupt control apparatus 700 according to a modification example of the third embodiment;

FIG. 12 is a flow chart that shows the interrupt control processing performed by the interrupt control apparatus 700; and

FIG. 13 is a flow chart that shows the instruction execution processing performed by the interrupt control apparatus 700.

### DESCRIPTION OF THE PREFERRED EMBODIMENT

### The First Embodiment

The following describes the interrupt control apparatus according to the first embodiment of the present invention.

Configuration

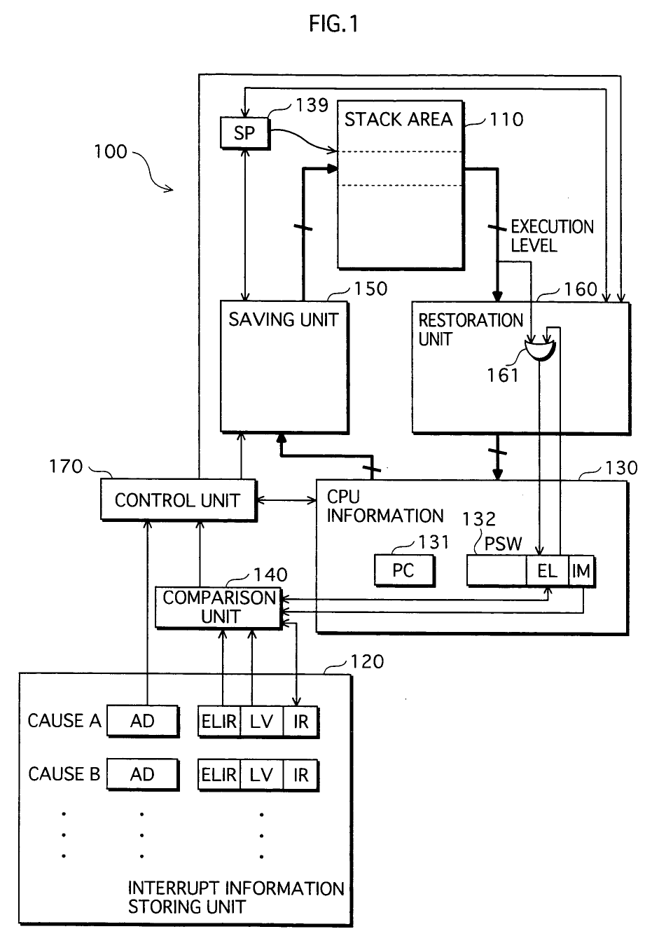

FIG. 1 is a functional block diagram of the interrupt control apparatus 100 according to the first embodiment.

The interrupt control apparatus 100 is a part of a computer comprising a CPU, a memory, and the like and is an apparatus that realizes interrupt control. It should be noted that interrupt control is to suspend execution of a program when a specific interrupt cause has occurred while the CPU is executing the program and to execute a special interrupt processing that corresponds to the interrupt cause, and when the interrupt processing is finished, to resume execution of the original program that has been suspended.

As shown in the drawing, the interrupt control apparatus 100 comprises, in terms of its functions, a stack area 110, an interrupt information storing unit 120, a comparison unit 140, a saving unit 150, a restoration unit 160, and a control unit 170.

Here, the stack area 110 is an area within a memory. The stack pointer (SP) 139 is a register or an area of a memory that indicates a current data storing position in the stack area 110.

The interrupt information storing unit 120 is a storage area that stores therein, interrupt processing information AD such as an address for identifying an interrupt processing program, an execution level ELIR that indicates either a privileged level or a user level, an interrupt level LV that shows the priority levels among multiple interrupts, and an interrupt request flag IR that is set at a HIGH level (H) when an interrupt cause has occurred and is reset at a LOW level (L) immediately before an interrupt processing program for the interrupt cause is executed, while bringing these pieces of information in correspondence with one another. The interrupt information storing unit 120 is constituted with, for example, interrupt control registers for the particular purpose. It should be noted that when the execution level ELIR indicates HIGH (H), it means the execution level is a user level, and when the execution level ELIR indicates LOW (L), it means the execution level is a privileged level. As additional information, the content of the interrupt information storing unit 120 is set in advance by the OS when the system is activated or the like.

The saving unit 150 is operable to, in accordance with an instruction from the control unit 170, store the CPU information 130 into a current data storing position within the stack area 110.

Here, the CPU information 130 is the content of the processor status word (PSW) 132 which is a register showing the current status of the CPU and the content of the program counter (PC) 131 which is a register showing the execution address of a program. It should be noted that the PSW 132 includes (i) an execution level flag EL which indicates the current operation mode, i.e. the execution level of a currently executed program and (ii) an interrupt mask level flag IM which is used for judgment of whether multiple interrupts should be rejected. The execution level shows a level of authorization provided for a program with regards to use of the computer resources. A high execution level, which means that there is no particular restriction in use of the computer resources, is a privileged level. A low execution level, which means that there is restriction in terms of usable computer resources, is a user level.

The comparison unit 140 is operable to, when an interrupt cause has occurred, compare the interrupt level LV and the execution level ELIR that both correspond to the interrupt cause with the interrupt mask level flag IM and the execution level flag EL of the PSW 132 and to inform the control unit 170 of the comparison result.

Further, the control unit 170 is operable to read a program from a memory and decode and execute the program as well as to determine, when an interrupt cause has occurred, whether an interrupt should be accepted in accordance with the comparison result from the comparison unit 140. When an interrupt is to be accepted, the control unit 170 executes, after instructing the saving unit 150 to save the CPU information, an interrupt processing program identified by a piece of interrupt processing information AD that corresponds to the interrupt cause at a corresponding execution level ELIR. After finishing the execution of the interrupt processing program, the control unit 170 instructs the restoration unit 160 to restore the saved CPU information.

The restoration unit 160 is operable to, in accordance with an instruction from the control unit 170, restore the CPU information 130 immediately previously saved in the stack area 110 into the CPU. When this restoration is performed, in the case where the execution level flag EL in the PSW 132 within the CPU indicates a user level (H) after the CPU information saved in the stack area 110 is read, the restoration unit 160 forces the execution level flag in the read CPU information to indicate a user level (H), before restoring the CPU information into the CPU. It should be noted that this forcing action means to set a specific value regardless of what the original value is. This forcing action is realized by an OR logic gate 161 that is provided in the restoration unit 160 and takes the execution level flag EL in the PSW 132 and the execution level flag in the CPU information read from the stack area as an input and gives the output to the execution level flag EL in the PSW 132.

Operation

The following describes the operation of the interrupt control apparatus 100 having the aforementioned configuration.

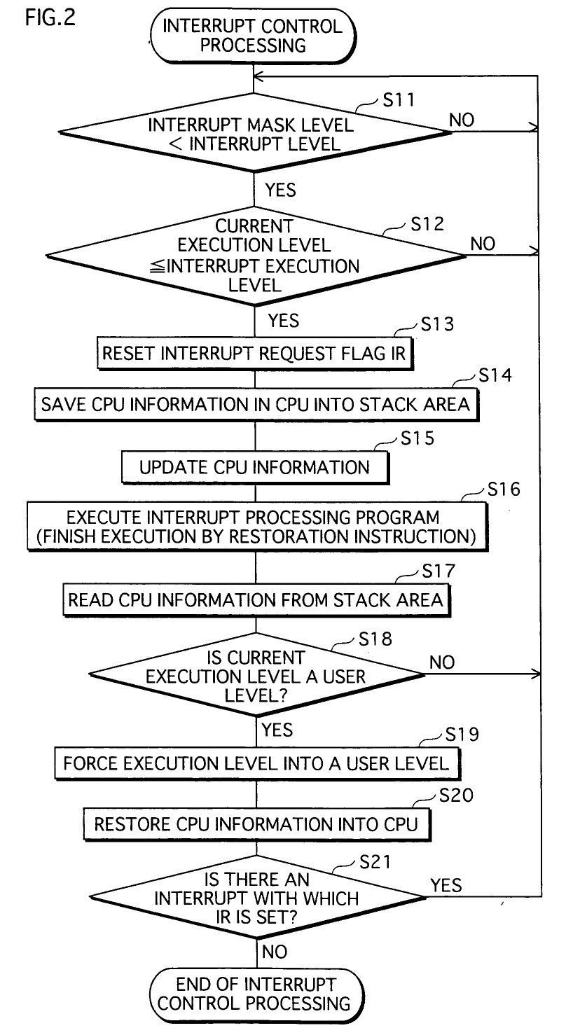

FIG. 2 is a flow chart that shows the interrupt control processing performed by the interrupt control apparatus 100.

Firstly, when an interrupt cause has occurred, an interrupt request flag IR within the interrupt information storing unit 120 corresponding to the interrupt cause is set at an H level by, for example, an interrupt controller outside the CPU.

Subsequently, having detected occurrence of an interrupt cause, the control unit 170 instructs the comparison unit 140 to compare the interrupt level LV that is stored in the interrupt information storing unit 120 and corresponds to the occurring interrupt cause with the interrupt mask level flag IM in the PSW 132 (Step S11). In the case where the interrupt level LV is at a level with a higher priority, the control unit 170 instructs the comparison unit 140 to compare the execution level ELIR corresponding to the interrupt cause with the execution level flag EL in the PSW 132 (Step S12), and if the execution level ELIR shows an execution level being equal to or higher than the execution level flag EL, the control unit 170 determines that the interrupt should be accepted and resets the interrupt request flag IR to be at an L level (Step S13). It should be noted that in the comparison in Step S12, the execution level ELIR shows an execution level being equal to or higher than the execution level flag EL, only when the execution level ELIR shows a privileged level or when the execution level ELIR shows a user level and also the execution level flag EL shows a user level.

In addition, in the case where the interrupt level LV is at a level with no higher priority than the interrupt mask level flag IM as a result of the comparison in Step S11, or in the case where the execution level ELIR shows a lower execution level than the execution level flag EL as a result of the comparison in Step S12, the control unit 170 determines that the interrupt should not be accepted.

After having accepted the interrupt request, the control unit 170 instructs the saving unit 150 to save the CPU information 130 in the CPU into the stack area 110 (Step S14). It should be noted that the saving unit 150 saves the CPU information 130 into part of the stack area 110 that can be specified by the SP 139 and changes the SP 139 by as much as what is stored.

After the CPU information 130 has been saved, the control unit 170 updates the CPU information 130 (Step S15). More specifically, the control unit 170 sets a value identical to the execution level ELIR corresponding to the interrupt cause for which the interrupt request has been accepted to be the execution level flag EL in the PSW 132, sets a value identical to the interrupt level LV corresponding to the interrupt cause to be the interrupt mask level flag IM in the PSW 132, and sets the address of an interrupt processing program into the PC 131 based on a piece of interrupt processing information AD corresponding to the interrupt cause.

Subsequent to Step S15, the control unit 170 executes the interrupt processing program in accordance with the PC 131 (Step S16). At this time, the interrupt processing program operates in an operation mode indicated by the corresponding execution level ELIR. More specifically, an interrupt processing program at a user level operates in a user mode, and an interrupt processing program at a privileged level operates in a privileged mode.

On a premise that a restoration instruction is provided at the end of the processing of the interrupt processing program, the control unit 170 finishes Step S16 when having read the restoration instruction.

It should be noted that in the case where another interrupt cause occurs while the control unit 170 is executing an interrupt processing program (Step S16), the interrupt control apparatus 100 performs a series of processing in and after Step S11 shown in FIG. 2 in response to this interrupt cause. Thus, the interrupt control apparatus 100 is able to cope with multiple interrupts.

After the execution of the interrupt processing program is finished, the control unit 170 instructs the restoration unit 160 to restore the CPU information that has been saved in the stack area 110 in Step S14.

At this time, the restoration unit 160 at first reads the CPU information from the part within the stack area 110 that can be specified by the SP 139 and changes the SP 139 by as much as the amount of the CPU information (Step S17). As a result of a function of the OR logic gate 161 referring to the execution level flag in the CPU information and the current execution level indicated by the execution level flag EL in the PSW 132, in the case where the current execution level flag EL shows a user level (H) (Step S18), the restoration unit 160 forces the execution level flag to be restored into the CPU to be at a user level (H) (Step S19), and restores the CPU information into the CPU (Step S20).

After the CPU information has been restored, if there exists an interrupt cause corresponding to the interrupt request flag IR being set at an H level, the control unit 170 continues to perform a series of processing in and after Step S11 with regard to such an interrupt cause. If no such interrupt cause exists, the control unit 170 finishes the interrupt control processing (Step S21).

The following describes the specific operation for interrupt control performed by the interrupt control apparatus 100.

There are Task a and Task c that are constituted by an interrupt processing program corresponding to an interrupt cause at a user level, and Task b that is constituted by an interrupt processing program corresponding to an interrupt cause at a privileged level. As for the priority levels shown by the interrupt levels, Task c is the highest, Task b is the second highest, and Task a is the lowest. The following description is based on an example in which an interrupt cause corresponding to Task a occurs at first, and then an interrupt cause corresponding to Task b occurs, and at last an interrupt cause corresponding to Task c occurs.

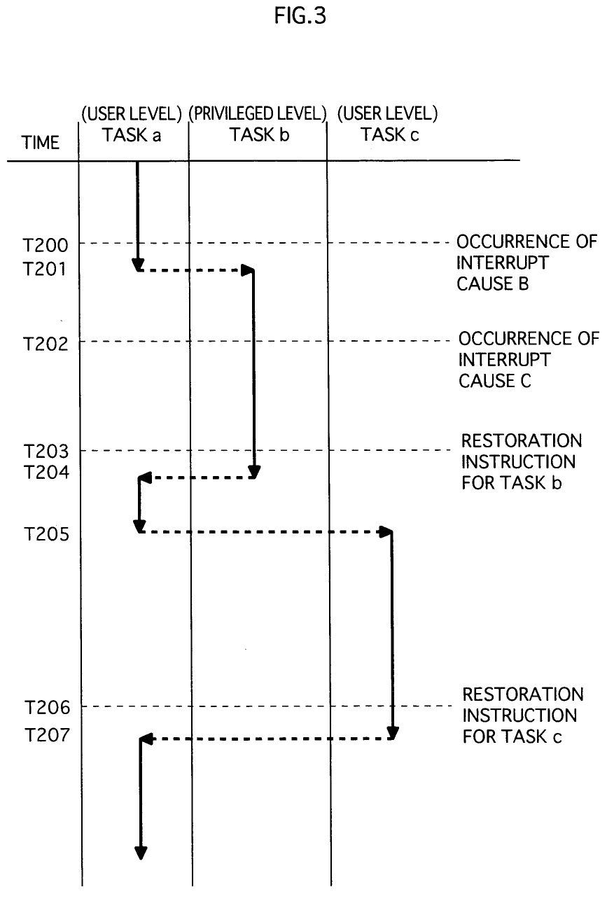

FIG. 3 is a timing chart that shows the relationship between occurrence of interrupt causes and execution of interrupt processing programs.

Firstly, Task a at a user level is being executed, and in correspondence with this, the interrupt mask level flag IM in the PSW 132 shows a low priority level, and the execution level flag EL shows a user level (H).

At a time T200, an interrupt cause B corresponding to Task b occurs. The interrupt request flag IR corresponding to the interrupt cause B is set at an H level. At a time T201, the interrupt level LV corresponding to the interrupt cause B shows a higher priority level than the interrupt mask level IM and also the execution level ELIR corresponding to Task b shows a privileged level (L) and is higher than the execution level flag EL; therefore, the interrupt is accepted, and the interrupt request flag IR is reset to be at an L level. Subsequently, the CPU information 130 is saved into the stack area 110, the interrupt mask level IM is updated, the execution level flag EL is set at a privileged level (L), and the interrupt processing program for Task b is executed.

Suppose, at a time T202, while the interrupt processing program for Task b is being executed, an interrupt cause C corresponding to Task c occurs, and the interrupt request flag IR corresponding to the interrupt cause C is set at an H level. The interrupt level LV corresponding to the interrupt cause C shows a higher priority level than the interrupt mask level IM, but the execution level ELIR corresponding to the interrupt cause C shows a user level (H) and is lower than the execution level flag EL at this point; therefore, the interrupt will not be accepted and will be suspended.

At a time T203, when a restoration instruction in the interrupt processing program for Task b is executed, the CPU information saved in the stack area 110 is restored into the CPU. In this restoration, the execution level remains at the user level (H) as it has been while being saved.

Subsequently, at a time T205, the interrupt level LV corresponding to the suspended interrupt cause C shows a higher priority level than the interrupt mask level IM and also the execution level ELIR corresponding to the interrupt cause C shows a user level (H) and the execution level flag EL at this point also shows a user level (H); therefore, as a result of the judgment made by the control unit 170 in Step S12, the interrupt is accepted, the interrupt request flag IR is reset to be at an L level, and the CPU information 130 is saved into the stack area 110. The interrupt mask level IM is updated, the execution level flag EL is set at a user level (H), and the interrupt processing program for Task c is executed.

At a time T206, when a restoration instruction in the interrupt processing program for Task c is executed, the CPU information saved in the stack area 110 is read by the restoration unit 160. Since the execution level flag EL in the PSW 132 at this point is at a user level (H), with the use of a function of the OR logic gate 161, the execution level flag in the CPU information is made to always show a user level (H), and the CPU information is restored into the CPU.

Accordingly, even if the interrupt processing program at a user level corresponding to Task c rewrites, while being executed, what is stored in the stack area 110, in other words, rewrites the saved CPU information, the execution level flag is forced to be at a user level (H) before being restored into the CPU. In other words, an arrangement made in which the execution level flag EL in the PSW within the CPU cannot be improperly set to be at a privileged level (L) even if there was an access to the stack area or noise by a user-level interrupt processing program having lower reliability. It should be noted that a program at a user level is not allowed to directly update the execution level flag EL in the PSW. Such an attempt of update operation will be dealt as a system error.

As explained so far, while an interrupt processing program at a privileged level having a high reliability is being executed, the interrupt control apparatus 100 does not accept an interrupt resulting from an interrupt cause that corresponds to an interrupt processing program at a user level. Further, when CPU information is restored after an interrupt processing program at a user level has been executed, the execution level flag EL is forced not to change to a privileged level. As a result, for example, an interrupt processing program at a user level is not able to take over a privileged level although the interrupt processing program is able to perform flexible control such as to change the value of a PC in the CPU information saved in the stack area so that an arbitrary program is to be executed after the interrupt processing is finished.

To summarize, the interrupt control apparatus 100 realizes a fail-safe function by which taking over of a privileged level is easily prevented with the use of the function of the comparison unit 140 comparing execution levels and the function of the OR logic gate 161, and the like. With this arrangement, it is not necessary to limit locations into which CPU information is saved to privileged protected areas within a memory which only privileged-level programs are able to access.

### MODIFICATION EXAMPLE

The following describes the interrupt control apparatus 200 obtained by modifying parts of the interrupt control apparatus 100.

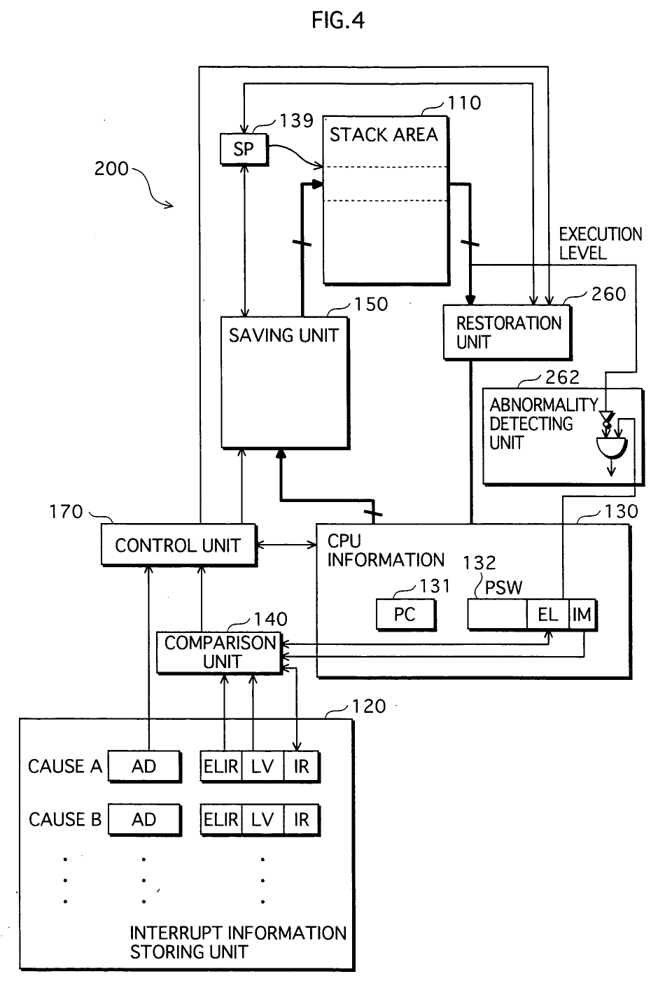

FIG. 4 is a functional block diagram of the interrupt control apparatus 200 according to a modification example of the first embodiment.

As shown in the drawing, the interrupt control apparatus 200 comprises, in terms of its functions, a stack area 110, an interrupt information storing unit 120, a comparison unit 140, a saving unit 150, a restoration unit 260, an abnormality detecting unit 262, and a control unit 170. In the drawing, some of the constituent elements of the interrupt control apparatus 200 that are the same with the ones in the interrupt control apparatus 100 have the same reference numbers. Description of the same constituent elements will be omitted.

The restoration unit 260 is operable to restore the CPU information 130 that has been immediately previously saved into the stack area 110 simply into the CPU, in accordance with an instruction from the control unit 170.

The abnormality detecting unit 262 is operable to input, when the restoration unit 260 is to restore the CPU information, part of the CPU information read from the stack area 110 that represents an execution level flag and the execution level flag EL within the PSW 132 at that point to a NOT gate and an AND logic gate, and to output, under a predetermined condition, a notification that an error has occurred to the outside of the interrupt control apparatus 200.

The interrupt control apparatus 200, which is different from the interrupt control apparatus 100 in comprising the restoration unit 260 and the abnormality detection unit 262, performs processing that is basically the same as the interrupt control processing shown in FIG. 2, except that the following processing is performed instead of Steps S18 and S19:

Only when both of the following (i) and (ii) are satisfied and when the outcome of the NOT gate and the AND logic gate is an H level, the abnormality detecting unit 262 outputs a notification that an error has occurred to the outside of the interrupt control apparatus 200: (i) the part of the CPU information read from the stack memory 110 that represents an execution level flag shows a privileged level (L), and (ii) the execution level flag EL in the PSW 132 at that point shows a user level (H).

Accordingly, while an interrupt processing program that has high reliability and is at a privileged level is being executed, in other words, an interrupt processing program having a high execution level is being executed, the interrupt control apparatus 200 does not accept an interrupt resulting from an interrupt cause corresponding to an interrupt processing program that has low reliability and is at a user level, in other words, an interrupt processing program having a low execution level. Also, when the CPU information is restored after an interrupt processing program at a user level finished being executed, the interrupt control apparatus 200 is able to detect if the execution level to be restored has been improperly set to be at a privileged level and to treat it as an error. Consequently, like with the interrupt control apparatus 100, an interrupt processing program at a user level is not able to take over a privileged level although the interrupt processing program is able to perform flexible control such as to change the value of a PC in the CPU information saved in the stack area so that an arbitrary program is to be executed after the interrupt processing is finished.

### The Second Embodiment

The following describes the interrupt control apparatus according to the second embodiment of the present invention.

Configuration

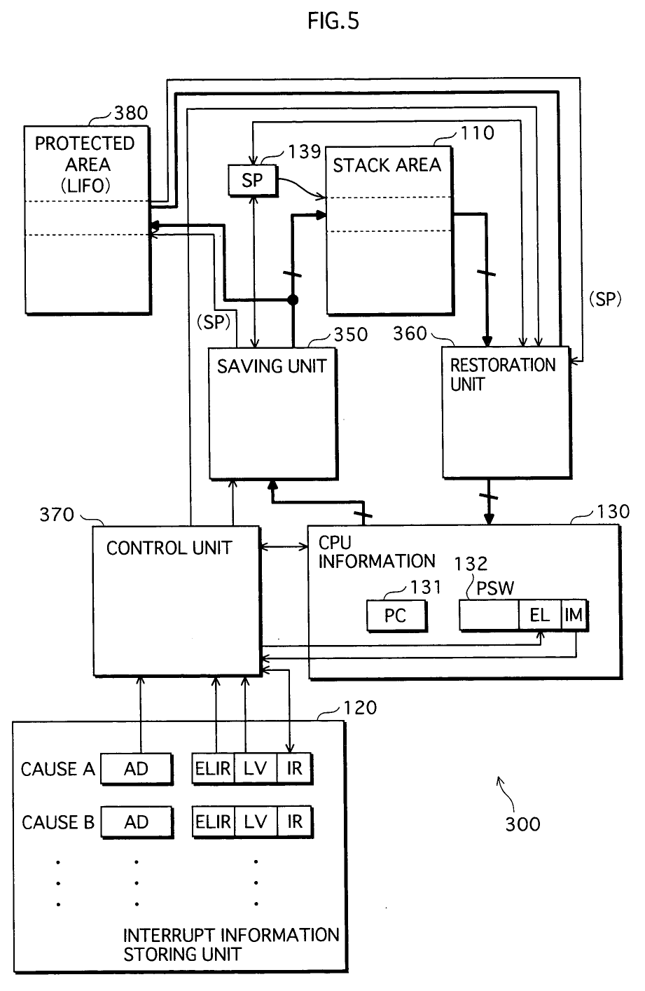

FIG. 5 is a functional block diagram of the interrupt control apparatus 300 according to the second embodiment.

The interrupt control apparatus 300 is a part of a computer comprising a CPU, a memory, and the like. As shown in the drawing, the interrupt control apparatus 300 comprises, in terms of its functions, a stack area 110, an interrupt information storing unit 120, a saving unit 350, a restoration unit 360, a control unit 370, and a protected area 380.

The interrupt control apparatus 300 includes constituent elements some of which are the same with those included in the interrupt control apparatus 100 in the first embodiment; however, the interrupt control apparatus 300 has a special mechanism for preventing a program at a user-level from taking over a privileged level while accepting, even if an interrupt processing program at a privileged level is being executed, an interrupt resulting from an interrupt cause that corresponds to an interrupt processing program at a user level. It should be noted that some of the constituent elements of the interrupt control apparatus 300 shown in FIG. 5 that are the same with the ones in the interrupt control apparatus 100 have the same reference numbers as used in FIG. 1. Description of the same constituent elements will be omitted.

The saving unit 350 is operable to, in accordance with an instruction from the control unit 370, store CPU information 130 identical to the one described for the first embodiment into the stack area 110 at a current data storing position as well as to store the CPU information 130 and the SP 139 into the protected area 380.

The restoration unit 360 is operable to, in accordance with an instruction from the control unit 370, store the content of the SP 139 that has been immediately previously saved in the protected area 380 into the SP 139, and to read the CPU information that has been immediately previously saved in the protected area 380 and the stack area 110. In the case where part of the CPU information read from the protected are 380 that represents an execution level flag indicates a privileged level, the restoration unit 360 is operable to restore the CPU information read from the protected area 380 into the CPU. In the case where the part representing an execution level flag indicates a user level, the restoration unit 360 is operable to restore, into the CPU, the part of the CPU information read from the protected area 380 representing the execution level flag and such part of the CPU information read from the stack area 110 that represents other than the execution level flag.

The control unit 370 is operable to read a program from a memory and to decode and execute the program. Also, when an interrupt cause has occurred, the control unit 370 is operable to determine whether the interrupt should be accepted or not by comparing an interrupt level LV that corresponds to the interrupt cause with an interrupt mask level flag IM in the PSW 132. In the case where the interrupt is to be accepted, the control unit 370 is operable to instruct the saving unit 350 to save the CPU information, then to execute an interrupt processing program identified by a piece of interrupt processing information AD that corresponds to the interrupt cause at a corresponding execution level ELIR, and to instruct the restoration unit 360 to restore the saved CPU information after the execution of the interrupt processing program is finished.

The protected area 380 is protected so that only programs at privileged levels are able to write data into this area. The protected area 380 is a storage area within a memory for which reading and writing of data is controlled in a last-in-first-out (LIFO) manner. This protection is realized with so-called ring protection, which is conventionally provided by a CPU or an OS. As the control unit 370 decodes and executes programs, if a program at a user level attempts to write data into the protected area 380, the control unit 370 inhibits the writing and treats it as a system error.

Operation

The following describes the operation of the interrupt control apparatus 300 having the aforementioned configuration.

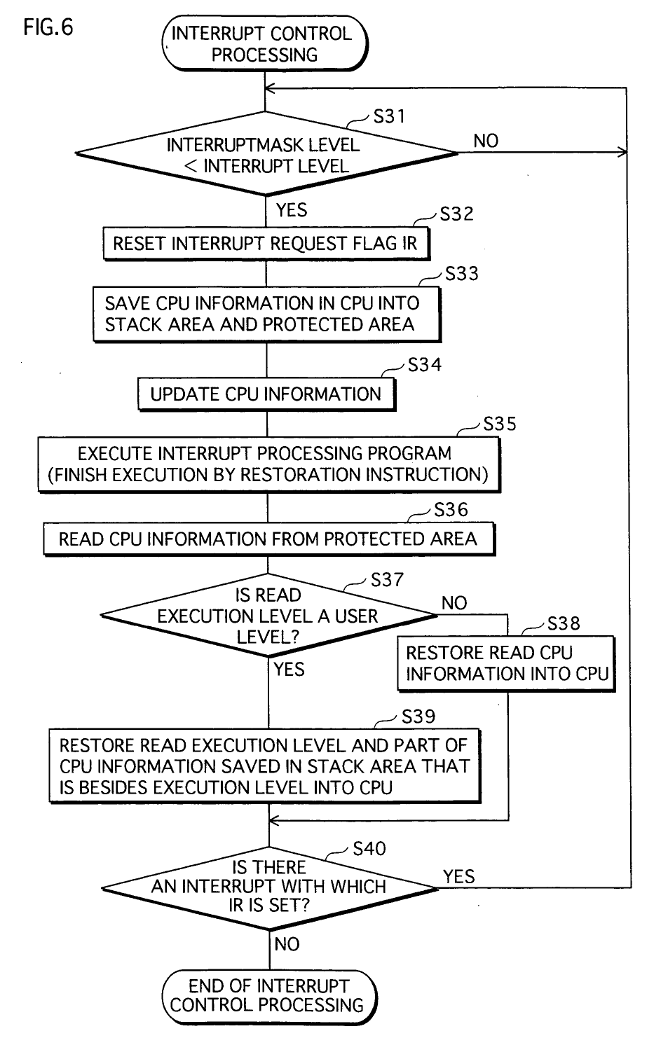

FIG. 6 is a flow chart that shows the interrupt control processing performed by the interrupt control apparatus 300.

Firstly, when an interrupt cause has occurred, an interrupt request flag IR that is in the interrupt information storing unit 120 and corresponds to the interrupt cause is set at an H level by, for example, an interrupt controller outside the CPU.

Subsequently, having detected occurrence of an interrupt cause, the control unit 370 compares the interrupt level LV that is stored in the interrupt information storing unit 120 and corresponds to the occurring interrupt cause with the interrupt mask level flag IM in the PSW 132 (Step S31). In the case where the interrupt level LV is at a level with a higher priority, the control unit 370 determines that the interrupt should be accepted and resets the interrupt request flag IR to be at an L level (Step S32). It should be noted that as a result of the comparison in Step S31 the interrupt level LV is at a level with no higher priority than the interrupt mask level flag IM, the control unit 370 determines that the interrupt should not be accepted.

After having accepted the interrupt request, the control unit 370 instructs the saving unit 350 to save the CPU information 130 in the CPU into the stack area 110 and saves the CPU information 130 and the SP 139 into the protected area 380 (Step S33). It should be noted that the saving unit 350 saves the CPU information 130 into a part of the stack area 110 that can be specified with the SP 139 and changes the SP 139 by as much as what is stored.

After the CPU information 130 has been stored, the control unit 370 updates the CPU information 130 (Step S34). More specifically, the control unit 370 sets a value identical to the execution level ELIR corresponding to the interrupt cause for which the interrupt request has been accepted to be the execution level flag EL in the PSW 132, sets a value identical to the interrupt level LV corresponding to the interrupt cause to be the interrupt mask level flag IM in the PSW 132, and sets the address of an interrupt processing program into the PC 131 based on the piece of interrupt processing information AD corresponding to the interrupt cause.

Subsequent to Step S34, the control unit 370 executes the interrupt processing program in accordance with the PC 131 (Step S35). At this time, the interrupt processing program operates in an operation mode indicated by the corresponding execution level ELIR. More specifically, an interrupt processing program at a user level operates in a user mode, and an interrupt processing program at a privileged level operates in a privileged mode.

On a premise that a restoration instruction is provided at the end of the processing of the interrupt processing program, the control unit 370 finishes Step S35 when having read the restoration instruction.

It should be noted that in the case where another interrupt cause occurs while the control unit 370 is executing an interrupt processing program (Step S35), the interrupt control apparatus 300 performs a series of processing in and after Step S31 shown in FIG. 6 in response to this interrupt cause. Thus, the interrupt control apparatus 300 is able to cope with multiple interrupts.

After the execution of the interrupt processing program is finished, the control unit 370 instructs the restoration unit 360 to restore the CPU information that has been saved in the protected area 380 and the stack area 110 in Step S33.

At this time, the restoration unit 360 at first reads the SP from the protected area 380 and restores the read SP into the CPU, reads the CPU information from the protected area 380 and the stack area 110 (Step S36) and updates the SP 139 by as much as the amount of the read CPU information. The restoration unit 360 judges whether the execution level flag in the CPU information read from the protected area 380 indicates a user level or not (Step S37), and if the execution level flag does not show a user level, i.e. if the execution level flag shows a privileged level, the restoration unit 360 restores the CPU information read from the protected area 380 into the CPU (Step S38).

Further, having judged that the execution level flag shows a user level in Step S37, the restoration unit 360 restores the execution level flag read from the protected area 380 into the CPU as the execution level flag EL in the PSW 132, as well as restores, into the CPU, such part of the CPU information read from the stack area 110 that represents other than the execution level flag as a content of the PSW 132 (Step S39).

After the CPU information has been restored in Steps S38 and Step S39, if there exists an interrupt cause corresponding to the interrupt request flag IR being set at an H level, the control unit 370 continues to perform a series of processing in and after Step S31 with regard to such an interrupt cause. If no such interrupt cause exists, the control unit 370 finishes the interrupt control processing (Step S40).

The following describes the specific operation for interrupt control performed by the interrupt control apparatus 300.

There are Task b that is constituted by an interrupt processing program corresponding to an interrupt cause at a privileged level and Task c and Task d that are constituted by an interrupt processing program corresponding to an interrupt cause at a user level. As for the priority levels shown by the interrupt levels, Task d is the highest, Task c is the second highest, and Task b is the lowest. The following description is based on an example in which an interrupt cause corresponding to Task b occurs at first, and while an interrupt processing program corresponding to Task b is being executed, an interrupt cause corresponding to Task c occurs, and then an interrupt cause corresponding to Task d occurs.

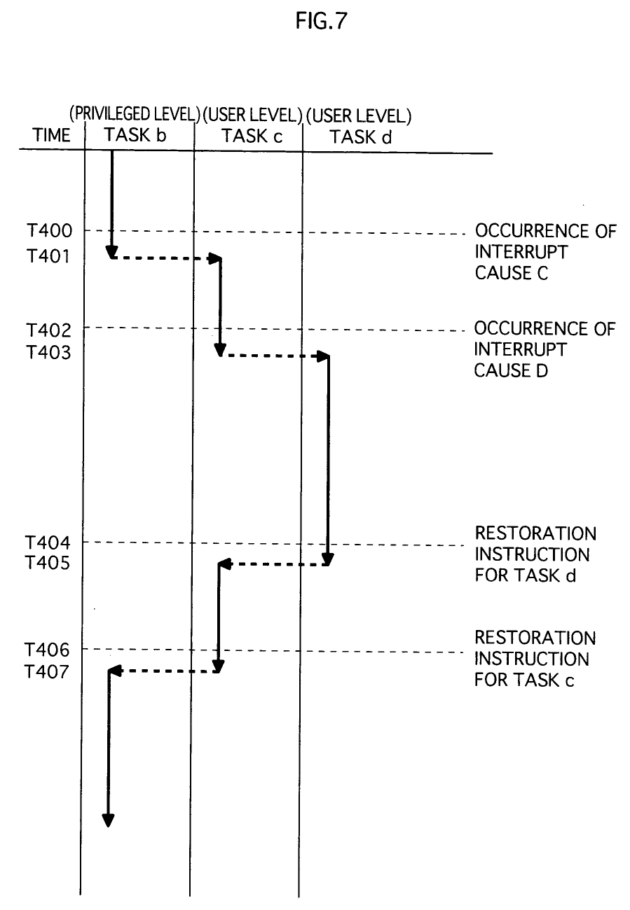

FIG. 7 is a timing chart that shows the relationship between occurrence of interrupt causes and execution of interrupt processing programs.

Firstly, Task b at a privileged level is being executed, and in correspondence with this, the interrupt mask level flag IM in the PSW 132 shows a low priority level, and the execution level flag EL shows a privileged level.

At a time T400, an interrupt cause C corresponding to Task c occurs. The interrupt request flag IR corresponding to the interrupt cause C is set at an H level. At a time T401, the interrupt level LV corresponding to the interrupt cause B shows a higher priority level than the interrupt mask level IM; therefore, as a result of the judgment by the control unit 370 in Step S31, the interrupt is accepted, and the interrupt request flag IR is reset to be at an L level. Subsequently, the SP is saved into the protected area 380, the CPU information 130 is saved into the stack area 110 and the protected area 380, and the SP is updated by as much as what is saved. The control unit 370 updates the interrupt mask level IM, sets the execution level flag EL to be at a user level, and starts executing the interrupt processing program for Task c.

Suppose, at a time T402, while the interrupt processing program for Task c is being executed, an interrupt cause D corresponding to Task d occurs, and the interrupt request flag IR corresponding to the interrupt cause D is set to be at an H level. The interrupt level LV corresponding to the interrupt cause D shows a higher priority level than the interrupt mask level IM; therefore, as a result of the judgment made by the control unit 370 in Step S31, the interrupt is accepted, and the interrupt request flag IR is reset to be at an L level. Subsequently, the SP is saved into the protected area 380, and the CPU information 130 related to the execution of Task c is saved into the stack area 110 and the protected area 380. The SP is updated as much as what is saved. The control unit 370 updates the interrupt mask level IM, sets the execution level flag EL to be at a user level, and starts executing the interrupt processing program for Task d. Accordingly, the execution of the interrupt processing program for Task c is temporarily suspended.

Subsequently, at a time T404, when the restoration instruction in the interrupt processing program for Task d is executed, the restoration unit 360 reads the saved SP from the protected area 380 and restores the read SP into the CPU, and reads the saved CPU information from the protected area 380 and the stack area 110. Since the execution level flag read from the protected area 380 indicates a user level, the restoration unit 360 restores, into the CPU, the execution level flag and part of the CPU information read from the stack area 110 that represents other than the execution level flag, in Step S39. As a result of this, the execution of the interrupt processing program for Task c is resumed thereafter.

Subsequently, when a restoration instruction in the interrupt processing program for Task c has been executed, the restoration unit 360 reads the saved SP from the protected area 380 and restores the read SP into the CPU, and reads the CPU information saved in the protected area 380 and the stack area 110. Since the execution level flag read from the protected area 380 indicates a privileged level, the restoration unit 360 restores the CPU information read from the protected area 380 into the CPU in Step S38. As a result of this, the execution of the interrupt processing program at a privileged level corresponding Task b is resumed.

It should be noted that the interrupt processing program that is at a user level and corresponds to Task d is able to, while being executed, rewrite some parts of the CPU information saved in the stack area 110, for example, to rewrite a restoration destination address into an arbitrary address. In such a case, the rewritten data is restored into the CPU effectively as a PC or the like. However, even if the interrupt processing program that is at a user level and corresponds to Task d attempts to take over a privileged level by rewriting even the execution level in the CPU information stored in the stack area 110, the interrupt processing program is not able to take over the privileged level because when restoration from the interrupt processing program occurs, the execution level flag saved in the protected area 380 is restored into the CPU. In addition, interrupt processing programs at user levels are not able to rewrite the content of the protected area 380.

Further, even if the interrupt processing program corresponding to Task c has rewritten, while being executed, the CPU information saved in the stack area 110, it does not work effectively. When restoration from the interrupt processing program occurs, since the interrupt processing program corresponding to Task b, which is the restoration destination, is at a privileged level, the CPU information saved in the protected area 380 is to be restored into the CPU; therefore, execution of the interrupt processing program for Task b is resumed with the same CPU status as it was when the program was suspended.

As so far explained, in the case where an interrupt has occurred while a program at a user level is being executed and an interrupt processing program at a user level starts being executed, the interrupt control apparatus 300 inhibits the interrupt processing program from rewriting improperly an execution level flag into a privileged level although the interrupt control apparatus 300 allows the interrupt processing program to access the stack area and rewrite effectively the restoration destination address and the like.

### The Third Embodiment

The following describes the interrupt control apparatus according to the third embodiment of the present invention.

Configuration

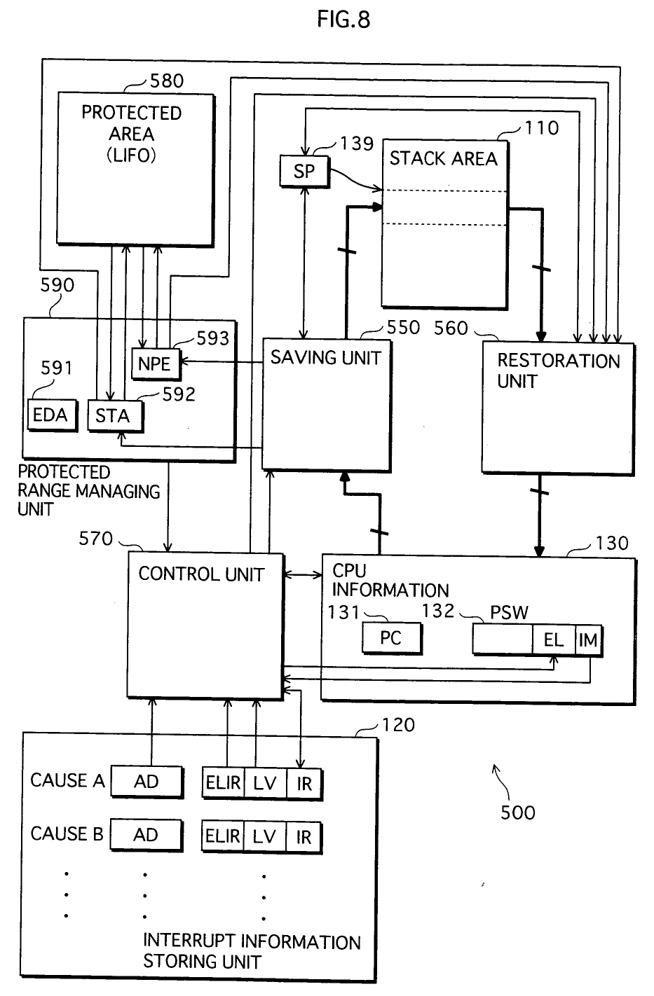

FIG. 8 is a functional block diagram of the interrupt control apparatus 500 according to the third embodiment.

The interrupt control apparatus 500 is a part of a computer comprising a CPU, a memory, and the like. As shown in the drawing, the interrupt control apparatus 500 comprises, in terms of its functions, a stack area 110, an interrupt information storing unit 120, a saving unit 550, a restoration unit 560, a control unit 570, a protected area 580, and a protected range managing unit 590.

The interrupt control apparatus 500 includes constituent elements some of which are the same with those included in the interrupt control apparatus 100 in the first embodiment; however, the interrupt control apparatus 500 is able to, with a configuration being different from that of the interrupt control apparatus 300 according to the second embodiment, realize a function of preventing a program at a user level from taking over a privileged level while accepting an interrupt resulting from an interrupt cause that corresponds to an interrupt processing program at a user level, even while an interrupt processing program at a privileged level is being executed. It should be noted that some of the constituent elements of the interrupt control apparatus 500 shown in FIG. 8 that are the same with the ones in the interrupt control apparatus 100 have the same reference numbers as used in FIG. 1. Description of the same constituent elements will be omitted.

The protected range managing unit 590 is a memory area into which only programs at privileged levels are able to write data. The content of the protected range managing unit 590 includes a protection ending address EDA 591, a protection starting address STA 592, and a protection flag NPE 593. An initial value of each of these items is set in advance by the OS. For example, each of the initial values of the protection ending address EDA 591 and the protection starting address STA 592 is the value of SP 139 shown when no data is stored in the stack area 110. The initial value of the protection flag NPE 593 is an L level.

The content of the protected range managing unit 590 is referred to by the control unit 570. In the case where the protection flag NPE 593 indicates an L level, the range starting from the memory address within the stack area indicated by the protection starting address STA 592 and ending with the memory address within the stack area indicated by the protection ending address EDA 591 is protected so that only programs at privileged levels are able to write data into this protected range. In the case where the protection flag NPE 593 indicates an H level, the range starting from the memory address within the stack area indicated by the protection starting address STA 592 plus 1 and ending with the memory address within the stack area indicated by the protection ending address EDA 591 is protected so that only programs at privileged levels are able to write data into this protected range.

In accordance with an instruction from the control unit 570, the saving unit 550 is operable to take the protection starting address STA and the protection flag NPE out of the protected range managing unit 590 and put them into the protected area 580, and to store the CPU information 130 being the same with the one described in the first embodiment into the stack area 110 at the current data storing position, i.e. the position indicated by the SP 139. The saving unit 550 is also operable to update the SP 139 by as much as what is stored, to store the content of the SP 139 into the protected range managing unit 590 as a protection starting address STA 592, and to store the content of the execution level flag EL in the CPU information 130 into the protected range managing unit 590 as a protection flag NPE 593.

In accordance with an instruction from the control unit 570, the restoration unit 560 is operable to set the protection starting address STA 592 within the protected range managing unit 590 to be the SP 139, and to read the CPU information that has immediately previously been saved into the stack area 110 and restore part of the CPU information that represents other than the execution level flag into the CPU. The restoration unit 560 is also operable to restore the protection flag NPE 593 within the protected range managing unit 590 as an execution level flag EL in the PSW 132 within the CPU, and to read the pair made up of the protection starting address and the protection flag that has immediately previously been stored into the protected area 580 and set them into the protected range managing unit 590 as a protection starting address STA 592 and a protection flag NPE 593.

The control unit 570 is operable to read a program from a memory and decode and execute the program as well as to determine, when an interrupt cause has occurred, whether an interrupt should be accepted by comparing the interrupt level LV corresponding to the interrupt cause with the interrupt mask level flag IM in the PSW 132. When an interrupt is to be accepted, the control unit 570 executes, after instructing the saving unit 550 to save the CPU information, an interrupt processing program identified by a piece of interrupt processing information AD that corresponds to the interrupt cause at a corresponding execution level ELIR. After finishing the execution of the interrupt processing program, the control unit 570 instructs the restoration unit 560 to restore the saved CPU information. It should be noted that, when decoding and executing a program, the control unit 570 inhibits a program at a user level to rewrite what is stored in a specific range within the stack area 110, by repeatedly performing an instruction execution processing, which is to be described later.

The protected area 580 is protected so that only programs at privileged levels are able to write data into this area. The protected area 580 is a storage area within a memory for which reading and writing of data is controlled in a last-in-first-out (LIFO) manner. This protection is realized with so-called ring protection, which is conventionally provided by a CPU or an OS. As the control unit 570 decodes and executes programs, if a program at a user level attempts to write data into the protected area 580, the control unit 570 inhibits the writing and treats it as a system error.

Operation

The following describes the operation of the interrupt control apparatus 500 having the aforementioned configuration.

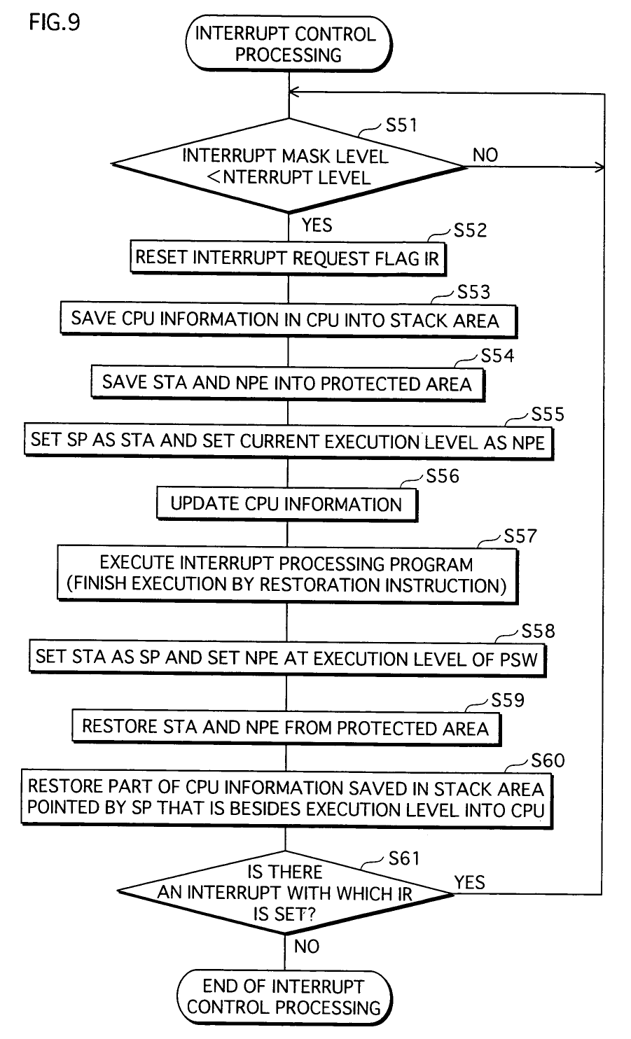

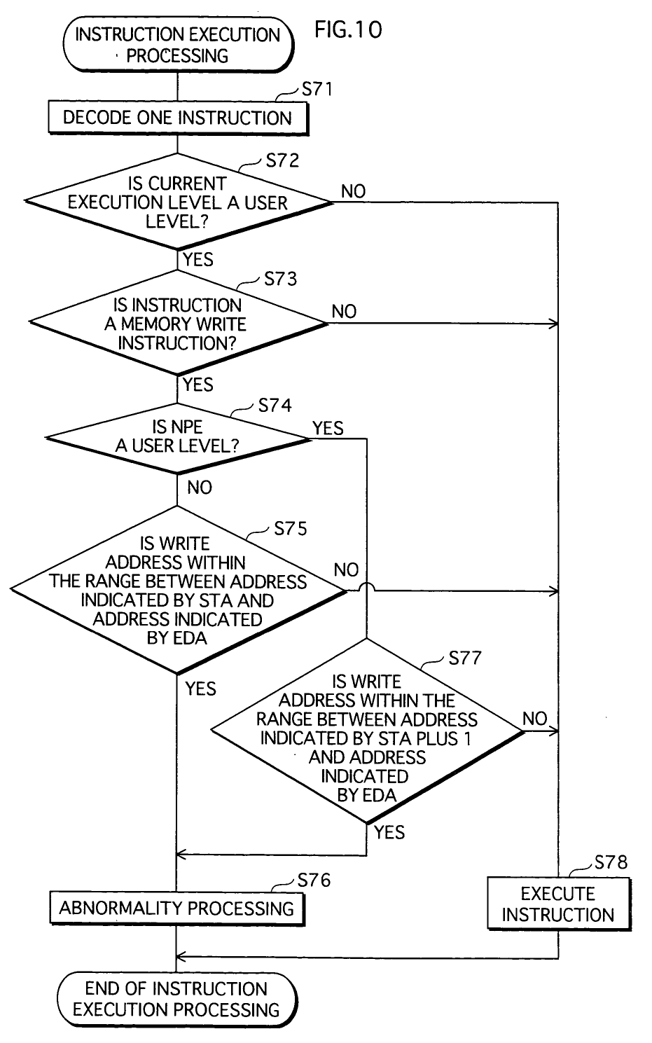

Firstly, the interrupt control processing will be described with reference to FIG. 9. Secondly, the instruction execution processing performed by the control unit 570 will be described with reference to FIG. 10.

FIG. 9 is a flow chart that shows the interrupt control processing performed by the interrupt control apparatus 500.

At first, when an interrupt cause has occurred, an interrupt request flag IR that is in the interrupt information storing unit 120 and corresponds to the interrupt cause is set at an H level by, for example, an interrupt controller outside the CPU.

Subsequently, having detected occurrence of an interrupt cause, the control unit 570 compares the interrupt level LV that is stored in the interrupt information storing unit 120 and corresponds to the occurring interrupt cause with the interrupt mask level flag IM in the PSW 132 (Step S51). In the case where the interrupt level LV is at a level with a higher priority, the control unit 570 determines that the interrupt should be accepted and resets the interrupt request flag IR to be at an L level (Step S52). It should be noted that as a result of the comparison in Step S51 the interrupt level LV is at a level with no higher priority than the interrupt mask level flag IM, the control unit 570 determines that the interrupt should not be accepted.

After having accepted the interrupt request, the control unit 570 instructs the saving unit 550 to save the CPU information 130 in the CPU into the stack area 110 (Step S53). In response to this instruction, the saving unit 550 saves the CPU information 130 into a part of the stack area 110 that can be specified with the SP 139 and changes the SP 139 by as much as what is stored. The saving unit 550 also saves the protection starting address STA and the protection flag NPE that are stored in the protected range managing unit 590 into the protected area 580 (Step S54). The saving unit 550 sets the content of the SP 139 into the protected range managing unit 590 as a protection starting address STA 592, and sets a value of the execution level flag in the CPU information 130 into the protected range managing unit 590 as a protection flag NPE 593 (Step S55).

It should be noted that in the interrupt control apparatus 500, a privileged level is expressed as an L level and a user level is expressed as an H level. Accordingly, in the case where the execution level of a program being executed when an interrupt request has been accepted is a privileged level (L), the protection flag NPE 593 is set at an L level in Step S55. In the case where the execution level of a program being executed when an interrupt request has been accepted is a user level (H), the protection flag NPE 593 is set at an H level in Step S55.

After the saving unit 550 has saved the CPU information 130, the control unit 570 updates the CPU information 130 (Step S56). More specifically, the control unit 570 sets a value identical to the execution level ELIR corresponding to the interrupt cause for which the interrupt request has been accepted to be the execution level flag EL in the PSW 132, sets a value identical to the interrupt level LV corresponding to the interrupt cause to be the interrupt mask level flag IM in the PSW 132, and sets the address of an interrupt processing program into the PC 131 based on the piece of interrupt processing information AD corresponding to the interrupt cause.

Subsequent to Step S56, the control unit 570 executes the interrupt processing program in accordance with the PC 131 (Step S57). At this time, the interrupt processing program operates in an operation mode indicated by the corresponding execution level ELIR. More specifically, an interrupt processing program at a user level operates in a user mode, and an interrupt processing program at a privileged level operates in a privileged mode.

On a premise that a restoration instruction is provided at the end of the processing of the interrupt processing program, the control unit 570 finishes Step S57 when having read the restoration instruction.

It should be noted that in the case where another interrupt cause occurs while the control unit 570 is executing an interrupt processing program (Step S57), the interrupt control apparatus 500 performs a series of processing in and after Step S51 shown in FIG. 9 in response to this interrupt cause. Thus, the interrupt control apparatus 500 is able to cope with multiple interrupts.

After the execution of the interrupt processing program is finished, the control unit 570 instructs the restoration unit 560 to restore the CPU information that has been saved in the stack area 110.

In response to this instruction, the restoration unit 560 restores the protection starting address STA 592 within the protected range managing unit 590 into the SP 139 and sets the protection flag NPE 593 within the protected range managing unit 590 to be the execution level flag EL in the PSW 132 (Step S58). The restoration unit 560 also restores the protection starting address STA and the protection flag NPE that have immediately previously been saved in the protected area 580 into the protected range managing unit 590 (Step S59). The restoration unit 560 further reads the CPU information saved in the stack area at a position indicated by the SP 139 and updates the SP 139 by as much as what has been read, and restores part of the CPU information that represents other than an execution level flag into the CPU (Step S60).

After the CPU information has been restored, if there exists an interrupt cause corresponding to the interrupt request flag IR being set at an H level, the control unit 570 continues to perform a series of processing in and after Step S51 with regard to such an interrupt cause. If no such interrupt cause exists, the control unit 570 finishes the interrupt control processing (Step S61).

FIG. 10 is a flow chart that shows the instruction execution processing performed by the interrupt control apparatus 500.

When decoding and executing a program, the control unit 570 performs the instruction execution processing shown in the drawing for each of the instructions in the program.

Firstly, the control unit 570 reads and decodes an instruction positioned at a memory address indicated by the PC 131 (Step 71). Subsequently, the control unit 570 judges whether or not the execution level flag EL in the PSW 132 indicates a user level (H) (Step S72). In the case where the execution level flag EL does not indicate a user level (H), but indicates a privileged level (L), the control unit 570 executes the decoded instruction according to the decoding result (Step S78). It should be noted that the function of reading an instruction in Step S71 and the function of executing an instruction in Step S78 are the same with functions of a conventional CPU.

Further, in the case where the execution level flag EL in the PSW 132 indicates a user level (H) in Step S72, the control unit 570 judges whether or not the instruction decoded in Step S71 is an instruction for writing data into a memory (Step S73). If the instruction is not for writing data into a memory, the control unit 570 executes the instruction according to the decoding result (Step S78). If the instruction is for writing data into a memory, the control unit 570 judges whether or not the protection flag NPE 593 in the protected range managing unit 590 indicates an H level, i.e. a user level (H) (Step S74).

In the case where the protection flag NPE 593 is judged to indicate a user level (H) in Step S74, the control unit 570 judges whether or not the memory address at which the data is to be written according to the write instruction is within the range starting from the protection starting address STA 592 plus 1 and ending with the protection ending address EDA 591, the protection starting and ending addresses 592 and 591 being stored in the protected range managing unit 590 (Step S77). Having judged that the memory address is within the range, the control unit 570 performs an abnormality processing such as treating the situation as a system error, or the like (Step S76). Having judged that the memory address is not within the range, the control unit 570 executes the instruction of writing data into the memory (Step S78).

In the case where the control unit 570 judges, in Step S74, that the protection flag NPE 593 does not indicate a user level (H) but indicates a privileged level (L), the control unit 570 judges whether or not the memory address at which the data is to be written according to the write instruction decoded in Step S71 is within the range starting from the protection starting address STA 592 and ending with the protection ending address EDA 591, the protection starting and ending addresses 592 and 591 being stored in the protected range managing unit 590 (Step S75). Having judged that the memory address is within the range, the control unit 570 performs an abnormality processing such as treating the situation as a system error, or the like (Step S76). Having judged that the memory address is not within the range, the control unit 570 executes the instruction of writing data into the memory (Step S78).

The following describes specific operation for interrupt control performed by the interrupt control apparatus 500, with reference to FIG. 7 which has been used to describe the operation of the interrupt control apparatus 300 in the second embodiment.

There are Task b that is constituted by an interrupt processing program corresponding to an interrupt cause at a privileged level and Task c and Task d that are constituted by an interrupt processing program corresponding to an interrupt cause at a user level. As for the priority levels shown by the interrupt levels, Task d is the highest, Task c is the second highest, and Task b is the lowest. The following description is based on an example in which an interrupt cause corresponding to Task b occurs at first, and while an interrupt processing program corresponding to Task b is being executed, an interrupt cause corresponding to Task c occurs, and then an interrupt cause corresponding to Task d occurs.

Firstly, Task b at a privileged level is being executed, and in correspondence with this, the interrupt mask level flag IM in the PSW 132 shows a low priority level, and the execution level flag EL shows a privileged level.

At a time T400, an interrupt cause C corresponding to Task c occurs. The interrupt request flag IR corresponding to the interrupt cause C is set at an H level. At a time T401, the interrupt level LV corresponding to the interrupt cause B shows a higher priority level than the interrupt mask level IM; therefore, as a result of the judgment by the control unit 570 in Step S51, the interrupt is accepted, and the interrupt request flag IR is reset to be at an L level. Subsequently, the CPU information 130 is saved into the stack area 110. The protection flag in the protected range managing unit 590 is set at an L level. The range starting from the protection starting address STA and ending with the protection ending address EDA is arranged so as to include the saved CPU information. The control unit 570 updates the interrupt mask level IM, sets the execution level flag EL to be at a user level, and starts executing the interrupt processing program for Task c.

The interrupt processing program for Task c is not able to rewrite the CPU information saved in the stack area 110, as a result of the instruction execution processing (FIG. 10) performed by the control unit 570 based on the protected range managing unit 590.

Suppose, at a time T402, while the interrupt processing program for Task c is being executed, an interrupt cause D corresponding to Task d occurs, and the interrupt request flag IR corresponding to the interrupt cause D is set at an H level. The interrupt level LV corresponding to the interrupt cause D shows a higher priority level than the interrupt mask level IM; therefore, as a result of the judgment made by the control unit 570 in Step S51, the interrupt is accepted, and the interrupt request flag IR is reset to be at an L level. Subsequently, the CPU information 130 related to the execution of Task c is saved into the stack area 110. The protection flag in the protected range managing unit 590 is set to be at an H level. The range starting from the protection starting address STA and ending with a protection ending address EDA is arranged so as to include all the CPU information that has been saved so far. The control unit 570 updates the interrupt mask level IM, sets the execution level flag EL to be at a user level, and starts executing the interrupt processing program for Task d. Accordingly, the execution of the interrupt processing program for Task c is temporarily suspended.

The interrupt processing program for Task d which starts being executed at this time is able to rewrite only part of the CPU information that has been saved into the stack area 110 last and is not able to rewrite other part of the CPU information and other pieces of CPU information, as a result of the instruction execution processing (FIG. 10) performed by the control unit 570 based on the protected range managing unit 590. An example of such part of CPU information that can be rewritten is a restoration destination address saved from the PC.

Subsequently, at a time T404, when the restoration instruction in the interrupt processing program for Task d has been executed, the restoration unit 560 restores the protection starting address STA 592 in the protected range managing unit 590 into the SP 139 and sets the protection flag NPE 593 in the protected range managing unit 590 to be the execution level flag EL in the PSW 132. The restoration unit 560 also restores, into the protected range managing unit 590, the protection starting address STA and the protection flag NPE that have immediately previously been saved in the protected area 580. The restoration unit 560 further reads the CPU information saved in the stack area indicated by the SP 139, updates the SP 139 as much as what has been read, and restores part of the CPU information that represents other than the execution level flag into the CPU. As a result, the execution of the interrupt processing program for Task c is resumed, thereafter.

Subsequently, when a restoration instruction in the interrupt processing program for Task c is executed, the restoration unit 560 restores the saved CPU information into the CPU, like in the previous case. As a result of this, the execution of the interrupt processing program corresponding Task b is resumed thereafter.

The interrupt processing program at a user level corresponding to Task d is able to rewrite, while being executed, some parts of the CPU information saved in the stack area 110, for example, to rewrite a restoration destination address into an arbitrary address. In such a case, the rewritten data is restored into the CPU effectively as a PC or the like. However, even if the interrupt processing program that is at a user level and corresponds to Task d attempts to take over a privileged level by rewriting even the execution level in the CPU information stored in the stack area 110, the interrupt processing program is not able to take over the privileged level because when restoration from the interrupt processing program occurs, the execution level flag saved in the protected range managing unit 590 is restored into the CPU. In addition, interrupt processing programs at user levels are not able to rewrite the content of each of the protected range managing unit 590 and the protected area 580.

Neither of the interrupt processing program corresponding to Task d and the interrupt processing program corresponding to Task c are able to rewrite the CPU information that is saved in the stack area 110 and is related to Task b; therefore, no interrupt processing program at a user level is able to improperly rewrite information for executing programs at privileged levels.

### Fourth Embodiment

The following describes an interrupt control apparatus according to the fourth embodiment of the present invention.

Configuration

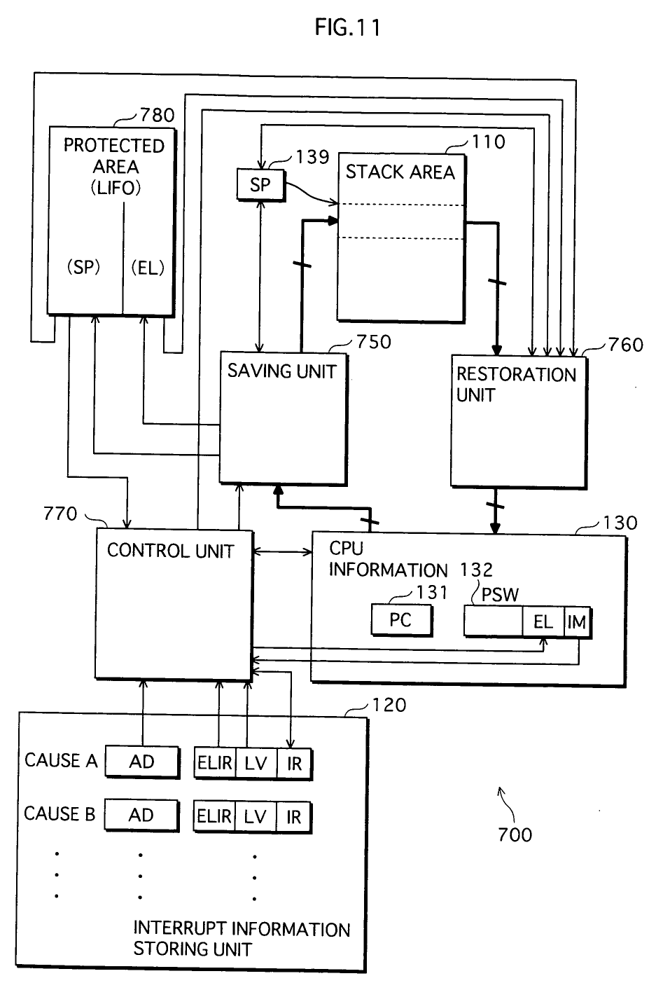

FIG. 11 is a functional block diagram of the interrupt control apparatus 700 according to the fourth embodiment.

The interrupt control apparatus 700 is a part of a computer comprising a CPU, a memory, and the like. As shown in the drawing, the interrupt control apparatus 700 comprises, in terms of its functions, a stack area 110, an interrupt information storing unit 120, a saving unit 750, a restoration unit 760, a control unit 770, and a protected area 780.

The interrupt control apparatus 700 is obtained by modifying only parts of the interrupt control apparatus 500 described in the third embodiment. Like the interrupt control apparatus 500, the interrupt control apparatus 700 is able to realize a function of preventing a program at a user level from taking over a privileged level while accepting an interrupt resulting from an interrupt cause that corresponds to an interrupt processing program at a user level, even while an interrupt processing program at a privileged level is being executed. It should be noted that some of the constituent elements of the interrupt control apparatus 700 shown in FIG. 11 that are the same with the ones in the interrupt control apparatus 500 have the same reference numbers as used in FIG. 1 or FIG. 8. Description of the same constituent elements will be omitted.

The protected area 780 is a storage area into which the saving unit 750 saves a pair made up of (i) the content of the SP 139 and (ii) a value of the execution level flag EL in the PSW 132. The protected area 780 is protected so that only programs at privileged levels are able to write data into this area. The protected area 780 is a storage area within a memory for which reading and writing of data is controlled in a last-in-first-out (LIFO) manner. This protection is realized with so-called ring protection, which is conventionally provided by a CPU or an OS. As the control unit 770 decodes and executes programs, if a program at a user level attempts to write data into the protected area 780, the control unit 770 inhibits the writing and treats it as a system error.

In accordance with an instruction from the control unit 770, the saving unit 750 is operable to save the CPU information 130 being the same with the one described in the third embodiment into the stack area 110 at the current data storing position, i.e. the position indicated by the SP 139. The saving unit 750 is also operable to update the value of the SP 139 by as much as what is saved, to store a pair made up of the content of the SP 139 and the value of the execution level flag EL in the PSW 132 into the protected area 780.

The restoration unit 760 is operable to, in accordance with an instruction from the control unit 770, read the pair made up of the SP value and the value of the execution level flag EL that has immediately previously been saved in the protected area 780 and to set them to be the SP 139 and the execution level flag EL in the PSW 132, respectively. The restoration unit 760 is further operable to read the CPU information saved in the stack area 110 at a position indicated by the SP 139, to restore part of the CPU information that represents other than the execution level flag into the CPU, and to update the SP 139 by as much as the part of the CPU information having been read.

The control unit 770 is operable to read a program from a memory and decode and execute the program as well as to determine, when an interrupt cause has occurred, whether an interrupt should be accepted by comparing the interrupt level LV corresponding to the interrupt cause with the interrupt mask level flag IM in the PSW 132. When an interrupt is to be accepted, the control unit 770 executes, after instructing the saving unit 750 to save the CPU information, an interrupt processing program identified by a piece of interrupt processing information AD that corresponds to the interrupt cause at a corresponding execution level ELIR. After finishing the execution of the interrupt processing program, the control unit 770 instructs the restoration unit 760 to restore the saved CPU information. It should be noted that, when decoding and executing a program, the control unit 770 inhibits a program at a user level to rewrite CPU information within the stack area 110 indicated by the SP that is saved in the protected area 780 as being paired up with the execution level flag indicating a privileged level, by repeatedly performing an instruction execution processing, which is to be described later.

Operation

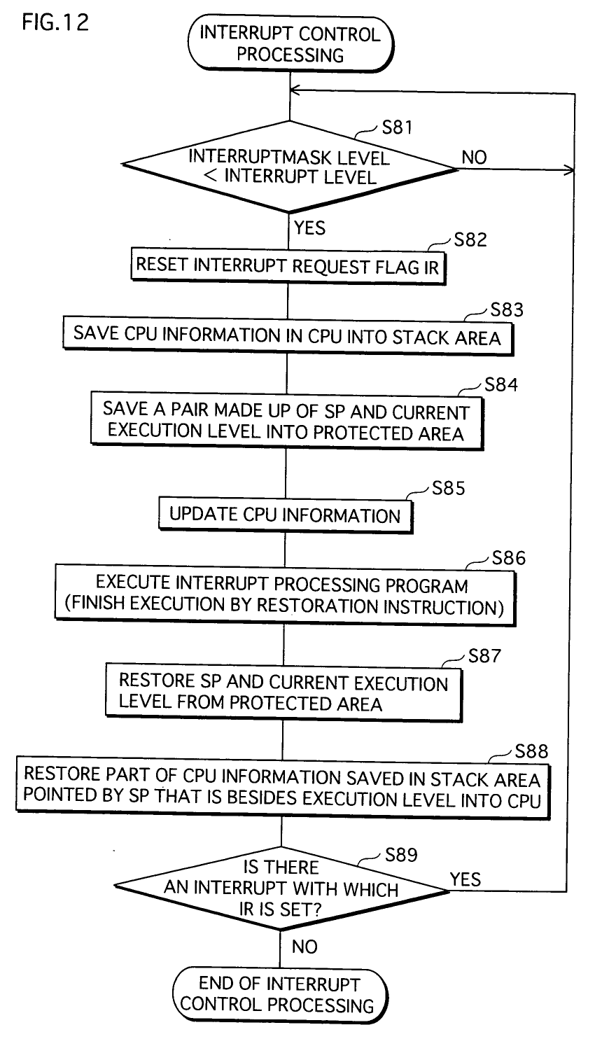

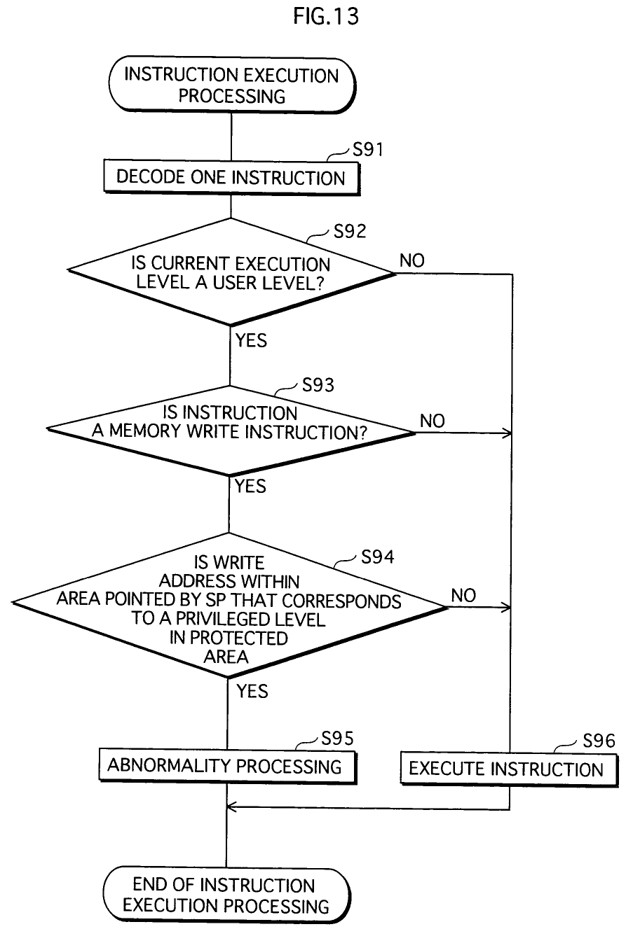

The following describes the operation of the interrupt control apparatus 700 having the aforementioned configuration. Firstly, the interrupt control processing will be described with reference to FIG. 12. Secondly, the instruction execution processing performed by the control unit 770 will be described with reference to FIG. 13.

FIG. 12 is a flow chart that shows the interrupt control processing performed by the interrupt control apparatus 700.

At first, when an interrupt cause has occurred, an interrupt request flag IR within the interrupt information storing unit 120 corresponding to the interrupt cause is set to be at an H level by, for example, an interrupt controller outside the CPU.

Subsequently, having detected occurrence of an interrupt cause, the control unit 770 compares the interrupt level LV that is stored in the interrupt information storing unit 120 and corresponds to the occurring interrupt cause with the interrupt mask level flag IM in the PSW 132 (Step S81). In the case where the interrupt level LV is at a level with a higher priority, the control unit 770 determines that the interrupt should be accepted and resets the interrupt request flag IR to be at an L level (Step S82). It should be noted that as a result of the comparison in Step S81 the interrupt level LV is at a level with no higher priority than the interrupt mask level flag IM, the control unit 770 determines that the interrupt should not be accepted.

After having accepted the interrupt request, the control unit 770 instructs the saving unit 750 to save the CPU information 130 in the CPU into the stack area 110 (Step S83). In response to this instruction, the saving unit 750 saves the CPU information 130 into a part of the stack area 110 that can be specified with the SP 139 (Step S83) and changes the SP 139 by as much as what is stored. The saving unit 750 also saves a pair made up of the content of the SP 139 and the execution level flag EL in the PSW 132 into the protected area 780 (Step S84).

After the saving unit 750 has saved the CPU information 130, the control unit 770 updates the CPU information 130 (Step S85). More specifically, the control unit 770 sets a value identical to the execution level ELIR corresponding to the interrupt cause for which the interrupt request has been accepted to be the execution level flag EL in the PSW 132, sets a value identical to the interrupt level LV corresponding to the interrupt cause to be the interrupt mask level flag IM in the PSW 132, and sets the address of an interrupt processing program into the PC 131 based on the piece of interrupt processing information AD corresponding to the interrupt cause.

Subsequent to Step S85, the control unit 770 executes the interrupt processing program in accordance with the PC 131 (Step S86). At this time, the interrupt processing program operates in an operation mode indicated by the corresponding execution level ELIR. More specifically, an interrupt processing program at a user level operates in a user mode, and an interrupt processing program at a privileged level operates in a privileged mode.

On a premise that a restoration instruction is provided at the end of the processing of the interrupt processing program, the control unit 770 finishes Step S86 when having read the restoration instruction.

It should be noted that in the case where another interrupt cause occurs while the control unit 770 is executing an interrupt processing program (Step S86), the interrupt control apparatus 700 performs a series of processing in and after Step S81 shown in FIG. 12 in response to this interrupt cause. Thus, the interrupt control apparatus 700 is able to cope with multiple interrupts.

After the execution of the interrupt processing program is finished, the control unit 770 instructs the restoration unit 760 to restore the CPU information that has been saved in the stack area 110.

In response to this instruction, the restoration unit 760 sets the value of the SP saved in the protected area 780 to be the SP 139 and sets the value of the saved execution level flag to be the execution level flag EL in the PSW 132 (Step S87). The restoration unit 760 further restores, into the CPU, part of the CPU information saved in the stack area 110 indicated by the SP 139 that represents other than the execution level flag (Step S88).

After the CPU information has been restored, if there exists an interrupt cause corresponding to the interrupt request flag IR being set at an H level, the control unit 770 continues to perform a series of processing in and after Step S81 with regard to such an interrupt cause. If no such interrupt cause exists, the control unit 770 finishes the interrupt control processing (Step S89).

FIG. 13 is a flow chart that shows the instruction execution processing performed by the interrupt control apparatus 700.

When decoding and executing a program, the control unit 770 performs the instruction execution processing shown in the drawing for each of the instructions in the program.

Firstly, the control unit 770 reads and decodes an instruction positioned at a memory address indicated by the PC 131 (Step S91). Subsequently, the control unit 770 judges whether or not the execution level flag EL in the PSW 132 indicates a user level (Step S92). In the case where the execution level flag EL does not indicate a user level, but indicates a privileged level, the control unit 770 executes the decoded instruction according to the decoding result (Step S96). It should be noted that the function of reading an instruction in Step S91 and the function of executing an instruction in Step S96 are the same with functions of a conventional CPU.

Further, in the case where the execution level flag EL in the PSW 132 indicates a user level in Step S92, the control unit 770 judges whether or not the instruction decoded in Step S91 is an instruction for writing data into a memory (Step S93). If the instruction is not for writing data into a memory, the control unit 770 executes the instruction according to the decoding result (Step S96). If the instruction is for writing data into a memory, the control unit 770 judges whether or not the memory address at which the data is to be written according to the write instruction is within the range in the stack area 110 that is for the amount of CPU information indicated by the SP stored in the protected area 780 as being paired up with the execution level flag indicating a privileged level (Step 94).

Having judged that the memory address used for the writing is within the range in Step S94, the control unit 770 performs abnormality processing such as treating the situation as a system error or the like (Step S95). Having judged that the memory address used for the writing is not within the range, the control unit 770 executes the writing instruction (Step S96).

As a result of the control according to Step S94, an interrupt processing program at a user level is inhibited from rewriting, out of the CPU information saved in the stack area 110, such part of the CPU information that indicates the execution status of a program at a privileged level whose execution is temporarily suspended due to an interrupt, although an interrupt processing program at a user level is allowed to rewrite, out of the CPU information saved in the stack area 110, such part of the CPU information that indicates the execution status of a program at a user level whose execution is temporarily suspended due to an interrupt.

The following describes specific operation for interrupt control performed by the interrupt control apparatus 700, with reference to FIG. 7, which has been used to describe the operation of the interrupt control apparatus 500 in the third embodiment.

There are Task b that is constituted by an interrupt processing program corresponding to an interrupt cause at a privileged level and Task c and Task d that are constituted by an interrupt processing program corresponding to an interrupt cause at a user level. As for the priority levels shown by the interrupt levels, Task d is the highest, Task c is the second highest, and Task b is the lowest. The following description is based on an example in which an interrupt cause corresponding to Task b occurs at first, and while an interrupt processing program corresponding to Task b is being executed, an interrupt cause corresponding to Task c occurs, and then an interrupt cause corresponding to Task d occurs.

Firstly, Task b at a privileged level is being executed, and in correspondence with this, the interrupt mask level flag IM in the PSW 132 shows a low priority level, and the execution level flag EL shows a privileged level.

At a time T400, an interrupt cause C corresponding to Task c occurs. The interrupt request flag IR corresponding to the interrupt cause C is set to be at an H level. At a time T401, the interrupt level LV corresponding to the interrupt cause B shows a higher priority level than the interrupt mask level IM; therefore, as a result of the judgment by the control unit 770 in Step S81, the interrupt is accepted, and the interrupt request flag IR is reset to be at an L level. Subsequently, the CPU information 130 is saved into the stack area 110. A pair being made up of the SP and an execution level flag indicating a privileged level is saved into the protected area 780. The control unit 770 updates the interrupt mask level IM, sets the execution level flag EL to be at a user level, and starts executing the interrupt processing program for Task c.

The interrupt processing program for Task c is not able to rewrite such part of the CPU information that is saved in the stack area 110 and is related to Task b, as a result of the instruction execution processing (FIG. 13) performed by the control unit 770.

Suppose, at a time T402, while the interrupt processing program for Task c is being executed, an interrupt cause D corresponding to Task d occurs, and the interrupt request flag IR corresponding to the interrupt cause D is set to be at an H level. The interrupt level LV corresponding to the interrupt cause D shows a higher priority level than the interrupt mask level IM; therefore, as a result of the judgment made by the control unit 770 in Step S81, the interrupt is accepted, and the interrupt request flag IR is reset to be at an L level. Subsequently, the CPU information 130 related to the execution of Task c is saved into the stack area 110. A pair being made up of the SP and an execution level flag indicating a user level is saved into the protected area 780. The control unit 770 updates the interrupt mask level IM, sets the execution level flag EL to be at a user level, and starts executing the interrupt processing program for Task d. Accordingly, the execution of the interrupt processing program for Task c is temporarily suspended.

As a result of the instruction execution processing (FIG. 13) performed by the control unit 770, the interrupt processing program for Task d which starts being executed at this time is able to rewrite only the CPU information that has been saved into the stack area 110 last and is related to Task c. The interrupt processing program for Task d, however, is not able to rewrite the CPU information related to Task b.

Subsequently, at a time T404, when the restoration instruction in the interrupt processing program for Task d has been executed, the restoration unit 760 restores the SP 139 and the execution level flag EL in the PSW 132 from the protected area 780, and restores such part of the CPU information saved in the stack area 110 indicated by the SP 139 that represents other than the execution level flag into the CPU. As a result, the execution of the interrupt processing program for Task c is resumed, thereafter.

Subsequently, when a restoration instruction in the interrupt processing program for Task c is executed, the restoration unit 760 restores the saved CPU information into the CPU, like in the previous case. As a result of this, the execution of the interrupt processing program corresponding Task b is resumed thereafter.

It should be noted that the interrupt processing program at a user level corresponding to Task d is able to rewrite, while being executed, some parts of the CPU information saved in the stack area 110, for example, to rewrite such part of the CPU information that is related to Task c and thereby is able to rewrite, for example, a restoration destination address into an arbitrary address. In such a case, the rewritten data is restored into the CPU effectively as a PC or the like. However, even if the interrupt processing program that is at a user level and corresponds to Task d attempts to take over a privileged level by rewriting even the execution level in the CPU information stored in the stack area 110, the interrupt processing program is not able to take over the privileged level because when restoration from the interrupt processing program occurs, the execution level flag saved in the protected area 780 is restored into the CPU. In addition, interrupt processing programs at user levels are not able to rewrite the content of the protected area 780.

Neither of the interrupt processing program corresponding to Task d and the interrupt processing program corresponding to Task c are able to rewrite such part of the CPU information that is saved in the stack area 110 and is related to Task b; therefore, no interrupt processing program at a user level is able to improperly rewrite information for executing programs at privileged levels.

Supplementary Information

The first through fourth embodiments of the present invention have been explained so far. The interrupt control apparatuses described in the embodiments may be partially modified as below:

(1) Allotment of functions to the functional elements constituting the interrupt control apparatus according to each embodiment is not limited to the examples described in the embodiments. For example, it is acceptable that the control unit, the saving unit, and the restoration unit are integrally installed as one functional block of a CPU. Alternatively, it is acceptable to realize some of their functions by having a CPU execute a program at a privileged level such as an OS.

(2) In the interrupt control apparatus according to each embodiment, what is stored in the interrupt information storing unit 120 is set by an OS when the system is activated or the like; however, it is also acceptable to have an arrangement wherein an OS or the like receives a request from a program at a user level for registration of an interrupt processing program at a user level, and the OS updates what is stored in the interrupt information storing unit 120 in accordance with the request for registration. However, it is necessary for the OS or the like to set, in response to such a request for registration, the execution level ELIR registered into the interrupt information storing unit 120 to be always at a user level.

(3) In the embodiments, the CPU information being the targets to be and restored when an interrupt occurs are the PSW and the PC; however, it is acceptable to have the CPU information contain the contents of some of general registers or some special registers of the CPU.

(4) In the first through fourth embodiments, only two execution levels such as a user level and a privileged level are described; however, it is acceptable to have three or more execution levels. Among three or more execution levels, the higher the execution level is, the wider the authorized range related to utilization of computer resources is and the more computer resources are usable. It is possible to generally classify those three or more execution levels as a high level and a low level. In such a case, the high level is a generic term for an execution level provided for programs with high reliability such as an OS and the like, and the low level is a generic term for an execution level provided for user programs that may contain an illegitimate program.

(5) The interrupt processing apparatus according to the first embodiment compares the priority levels by comparing the interrupt mask level flag IM with the interrupt level LV; however, it is acceptable to have an arrangement wherein the priority levels are compared only in the case where the execution level flag EL is identical to the execution level ELIR. Alternatively, it is acceptable to realize an interrupt processing apparatus of the present invention without the configuration to compare the priority levels.

(6) In the third embodiment, an arrangement is made in which, in the case where the protection flag NPE within the protected range managing unit 590 indicates a user level, a program at a user level is prevented from rewriting such a part of the stack area that ranges from an address indicated by the protection starting address STA plus one to an address indicated by the protection ending address EDA; however, it is acceptable to have an arrangement wherein a program at a user level is prevented from rewriting such apart of the stack area that ranges from an address obtained by adding the amount of CPU information to an address indicated by the protection starting address STA to an address indicated by the protection ending address EDA.

(7) In the fourth embodiment, a pair being made up of the SP and the execution level flag EL is saved into the protected area; however, it is acceptable to have an arrangement wherein saving the execution level flag EL is omitted and a program at a user level is prevented from rewriting such part of the CPU information within the stack area that is indicated by the SP stored in the protected area, regardless of what the execution level is.

The present invention is applicable to interrupt control in a computer system in which programs are classified into a plurality of execution levels and have different levels of usability of computer resources.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. An interrupt control apparatus for controlling multiple interrupts, comprising:
an interrupt information storing unit pre-storing therein, for each of a plurality of interrupt causes, (i) a piece of interrupt processing information for identifying a corresponding interrupt processing program to be executed in response to occurrence of the interrupt cause and (ii) a piece of level information indicating whether an execution level of the corresponding interrupt processing program is a high level or a low level;
a comparison unit operable to compare, when an interrupt cause has occurred, the execution level indicated by the piece of level information corresponding to the interrupt cause with an execution level indicated by a processor status word within a CPU;
a saving unit operable to save CPU information into a stack area within a memory, the CPU information including a content of the processor status word and a content of a program counter within the CPU;
a restoration unit operable to read the saved CPU information from the stack area and restores the read CPU information into the CPU; and
an interrupt control unit operable to, in a case where a result of the comparison shows that the execution level indicated by the piece of level information corresponding to the interrupt cause is no lower than the execution level indicated by the processor status word, cause the saving unit to save the CPU information before the interrupt control unit executes the corresponding interrupt processing program at the corresponding execution level, and to cause the restoration unit to restore the CPU information after the execution of the corresponding interrupt processing program is finished.

2. The interrupt control apparatus of claim 1, wherein
in a case where the execution level indicated by the processor status word within the CPU indicates a low level after the saved CPU information is read from the stack area, the restoration unit forces the read CPU information to indicate a low level and restores the CPU information forced to indicate the low level into the CPU.

3. The interrupt control apparatus of claim 1, further comprising
an abnormality detection unit operable to, in a case where the execution level indicated by the processor status word within the CPU indicates a low level and also the CPU information read from the stack area by the restoration unit indicates a high level, output information indicating that abnormality has occurred to outside of the interrupt control apparatus.

4. An interrupt control apparatus for controlling multiple interrupts, comprising:
an interrupt information storing unit pre-storing therein, for each of a plurality of interrupt causes, (i) apiece of interrupt processing information for identifying a corresponding interrupt processing program to be executed in response to occurrence of the interrupt cause and (ii) a piece of level information indicating whether an execution level of the corresponding interrupt processing program is a high level or a low level;
a saving unit operable to save CPU information into both a stack area within a memory indicated by a predetermined register and a protected area that is predetermined within a memory, the CPU information including a content of a processor status word and a content of a program counter within a CPU, and to save a stack pointer which is a content of the predetermined register into the protected area;
a restoration unit operable to read the saved stack pointer from the protected area, to set the read stack pointer into the predetermined register, and to read the saved CPU information from the protected area and (i) in a case where such part of the CPU information read from the protected area that represents an execution level indicates a low level, to restore, into the CPU, the execution level part and such part of the CPU information saved in the stack area indicated by the predetermined register that represents other than an execution level and (ii) in a case where the execution level part of the CPU information read from the protected area indicates a high level, to restore, into the CPU, the CPU information read from the protected area;
a protection unit operable to, in a case where an execution level present in the CPU indicates a low level, prevent an instruction for having data written into the protected area from being executed; and
an interrupt control unit operable to, when an interrupt cause has occurred, cause the saving unit to save the CPU information before the interrupt control unit executes the corresponding interrupt processing program, and to cause the restoration unit to restore the CPU information after the execution of the corresponding interrupt processing program is finished.

5. An interrupt control apparatus for controlling multiple interrupts, comprising:
an interrupt information storing unit pre-storing therein, for each of a plurality of interrupt causes, (i) a piece of interrupt processing information for identifying a corresponding interrupt processing program to be executed in response to occurrence of the interrupt cause and (ii) a piece of level information indicating whether an execution level of the corresponding interrupt processing program is a high level or a low level;
a saving unit operable to save CPU information into a stack area within a memory indicated by a predetermined register, the CPU information including a content of a processor status word and a content of a program counter within a CPU, and to save a stack pointer which is a content of the predetermined register into a protected area within a memory;
a restoration unit operable to read the saved stack pointer from the protected area, to set the read stack pointer into the predetermined register, and to read the CPU information from the stack area indicated by the predetermined register, and to restore the read CPU information into the CPU;
a first protection unit operable to, in a case where an execution level present in the CPU indicates a low level, prevent an instruction for having data written into the protected area from being executed;
a second protection unit operable to, in the case where the execution level present in the CPU indicates a low level, prevent an instruction from being executed, the instruction being for having data written into one of stack areas indicated by stack pointers that are saved in the protected area and not yet read out; and
an interrupt control unit operable to, when an interrupt cause has occurred, cause the saving unit to save the CPU information before the interrupt control unit executes the corresponding interrupt processing program, and to cause the restoration unit to restore the CPU information after the execution of the corresponding interrupt processing program is finished.

6. The interrupt control apparatus of claim 5, wherein
the saving unit further saves, into the protected area, a pair made up of the stack pointer and an execution level indicated by the process status word within the CPU,
the instruction prevented from being executed by the second protection unit is only an instruction for having data written into such a stack area indicated by a stack pointer that is, out of the stack pointers saved in the protected area and not yet read out, paired up with an execution level indicating a high level, and
the restoration unit reads the pair made up of the stack pointer and the execution level from the protected area, sets the read stack pointer into the predetermined register, reads such part of the CPU information that represents other than an execution level from the stack area indicated by the predetermined register, and restores the read part of the CPU information and the read execution level into the CPU.

7. The interrupt control apparatus of claim 5, wherein
the saving unit further saves, into the protected area, a pair made up of the stack pointer and an execution level indicated by the process status word within the CPU,
(i) in a case where a stack pointer immediately previously saved in the protected area and not yet read out is paired up with an execution level indicating a high level, the second protection unit prevents an instruction from being executed, the instruction being for having data written into a range starting from an address shown by the stack pointer and ending with a predetermined address, and (ii) in a case where the stack pointer immediately previously saved in the protected area and not yet read out is paired up with an execution level indicating a low level, the second protection unit prevents an instruction from being executed, the instruction being for having data written into a range starting from an address obtained by incrementing or decrementing, by a predetermined amount, the address shown by the stack pointer toward the predetermined address and ending with the predetermined address, and
the restoration unit reads the pair made up of the stack pointer and the execution level from the protected area, sets the read stack pointer into the predetermined register, reads such part of the CPU information that represents other than an execution level from the stack area indicated by the predetermined register, and restores the read part of the CPU information and the read execution level into the CPU.
